(19) United States
(12) Patent Application Publication
(10) Pub. No.: US 2009/0083544 A1
(43) Pub. Date: Mar. 26, 2009

(54) SECURITY PROCESS FOR PRIVATE DATA STORAGE AND SHARING

(76) Inventors: Andrew Scholnick, Fairfax, VA (US); Michael Scholnick, East Meadow, NY (US)

Correspondence Address: Connolly Bove Lodge & Hutz LLP, Suite 1100, 1875 Eye Street, NW, Washington, DC, 20006, US

(21) Appl. No.: 12/198,070

(22) Filed: Aug. 25, 2008

Related U.S. Application Data
(60) Provisional application No. 60/957,504, filed on Aug. 23, 2007.

(51) Int. Cl. H04L 9/32

(52) U.S. Cl. 713/186

(57) ABSTRACT

A method and system for supplementing and/or replacing current security protocols and/or mechanisms used to store, manage and/or disseminate information for use on private data management devices and/or a private network and/or public network access provider's network. The system includes processing hardware, proprietary software, and firmware. The system protects private data without the need to trust the security or veracity of third parties and/or intermediate computers and/or networks. When a “user” stores data it is immediately protected from active and passive compromise attempts. Once protected and stored, data is never released and/or transferred unprotected. Only the authorized “receiver” of the data is capable of accessing the protected data. Encryption is used to enhance authentication of the participants and/or protection of the data. This method can be used in conjunction with other secure data transfer applications such as, but not limited to, Secure Socket Layer (SSL) encryption and/or the Secure Electronic Transaction (SET) protocol, etc. This method can also be used in conjunction with any data transfer mechanism such as, but not limited to, Ethernet, WiFi, Bluetooth, RFID transponders, etc.

### CROSS-REFERENCE TO RELATED APPLICATIONS

This application is a non-provisional application corresponding to co-pending U.S. Provisional Patent Application Ser. No. 60/957,504, filed on Aug. 23, 2007, the disclosure of which is hereby incorporated by reference herein in its entirety.

### BACKGROUND

1. Technical Field

The present disclosure, which is called InvisiData™, relates to providing portable secure storage for a person's private information. For example, if the person were an average American consumer, the private information would include, but not be limited to, a driver's license, credit card accounts, checking accounts, social security number, library card, personal medical information, etc. all of which would be stored and secured individually and/or in combination within a portable, tamper proof device.

Also, the present disclosure relates to providing authorized users a secure manner of access to private information securely stored on a portable device. For example, if the private information were a checking account number being used for a purchase, the users would be the “owner” of the account, a “retailer” from which an item is being purchased, and a “bank” at which the owner's account was maintained, however, only the owner and the bank would be considered authorized users. The disclosure relates to a method by which the retailer is allowed to transfer the private information to the bank for the owner but only the owner and the bank are allowed to see the private data in its original form. The disclosure also supports the reverse case, transfer without an intermediary, multiple authorized parties, bi-directional transfer, etc.

Lastly, the present disclosure also relates to the method for protecting the private data in a manner more secure and inviolable than conventional encryption methods. More specifically, the disclosure relates to a non-mathematical method for scrambling the data before it is encrypted, such that the scrambled data alone and/or in combination with the encryption is more secure than encryption alone.

2. Background of Related Art

The fear of having sensitive information, such as credit card numbers, medical data, and identification, stolen from an individual and used without permission has become so widespread that it has been given the name “Identity Theft”. There is a pervasive understanding that personal information is not secure.

People are learning to try to protect themselves, and still being unsuccessful, especially while doing commerce online. The types of information that are the most sensitive are financial information, disposable resources (money, credit and the like), and health information, especially if a person has a health condition that could affect their job, relationships, and/or family. People who need to secure their information don't know until it is too late.

With this awareness, citizens, businesses, and governments are attempting to secure information as much as possible. Unfortunately, every time a new level of security is added, it is quickly countered. Banks added a third ID check to your credit card; institutions have changed from social security number to unique ID numbers; additional encryption for online purchases; photo IDs; etc. The problem is, the one step in the process that has not been sufficiently controlled is “the human factor”. A problem that, until now, most people have viewed as “too much trouble” to effectively inhibit and which therefore, unfortunately, has not been pro-actively addressed.

Almost all transactions are exposed to multiple people. People inherently trust the people they see every day, and should be able to continue to. The clerk where they've gone for 20 years every morning for coffee, the family doctor, the bank teller. These are all people they should and can trust. It's the other people in the chain that represent the risk. If private information is manually keyed in, displayed in any way, or written, it's visible to anyone else within the vicinity of that transaction. With current technology (cell phone cameras, long distance listening devices, wireless “nanny cams”, etc.) the number of people that can see and store someone else's private information is increasing rapidly. Even without that, the paper that is involved in these transactions poses an additional threat, even when shredded by the institution. Even a simple thing like dinner delivery from a restaurant is a risk. Any person sitting in the restaurant who can hear your address repeated back, your credit card repeated back, your CVV number repeated back. All of these issues and countless more present as “the human factor”. A problem impacting individuals, businesses, and governments alike and virtually un-addressed by modern technology. The “Need to Know” concept that was once the purview of the military community is now solidly part of the civilian conscience. What is needed is a solution that removes “the human factor” as much as possible. One that protects the individual as well as larger institutions. A solution that pro-actively prevents the problem in a cost-effective manner, rather than dealing with the results of the problem retro-actively at much greater cost. This solution, disclosed herein, we call “InvisiData™” technology.

The “InvisiData™” technology is different from previous technologies in many ways. One excellent comparison can be made with regard to the Secure Electronic Transaction (SET) Protocol which attempts to address the application of internet purchasing security. One of the greatest weaknesses of SET is that it uses simple encryption to protect data on an inherently un-secure medium, e.g. a user's personal computer (PC). Any compromise to the computer, thus, allows compromise of the weakly protected, locally stored data. Another problem of SET is the requirement for third-party involvement in order to authenticate a user. Unfortunately, the process of acquiring authentication certificates is cumbersome and equally vulnerable to the first problem, compromise of the inherently un-secure PC. A stolen certificate file and it's corresponding electronic wallet data file requires the thief to identify only a single password before handing the thief all of the victim's stored credit cards. Similar issues are shared with many other widely used technologies such as ISAKMP, and IPSEC. For example, none of these technologies are of use other than for network-based transactions, they offer no protection at all for the credit-card itself and/or interactions where private data needs to be presented by it's owner. RFID transponders, as another example, do little to enhance data security, they simply mask the insecure nature of the transaction with a reduction of manual labor. Also, these transponders are useless for telephone or internet commerce, as well as having no value for medical and other private data. InvisiData™ solves these and other issues by introducing concepts, procedures, and functionality previously unavailable in other technologies.

### SUMMARY

The problem of unauthorized access to private information is solved by the present disclosure which provides the owner of private information the ability to securely store, transport, and use their information without risk of third-party compromise. By coordinating personalization of data security and doing so in an effectively transparent manner the bother of protecting against “the human factor” is removed, allowing pro-active prevention of private information theft. The system allows authorized parties to be privately protected. At no time during any transaction is any outsider able to see or capture information related to the transaction. It doesn't matter whether the transaction is financial in nature, medical in nature, or even security-related. There are effectively only two authorized individuals in the entire InvisiData™ transaction.

### BRIEF DESCRIPTION OF THE DRAWINGS

The invention will be further described in the following portions of this specification when taken in conjunction with the attached drawings in which

FIG. 1a is a schematic representation of the five major components of a comprehensive embodiment of the invention;

FIG. 1b is a block diagram of a typical SPID;

FIG. 2 represents the functions carried out by the Secure Data Storage Manager (SDSM);

FIG. 3 represents the functions carried out by the Secure Personal Information Device (SPID);

FIG. 4 represents the functions carried out by the Secure Data Reception Point (SDRP);

FIG. 5 represents the functions carried out by the Secure Data Collection Point (SDCP)

FIG. 6 represents functions executed in the course of user data storage in an SPID;

FIG. 7 represents functions executed in the course user data access of a SPID;

FIG. 8 represents functions executed in the course a data access from a SPID related to a financial transaction;

FIG. 9 represents functions executed in the course of a data access from a SPID via a SDTP;

FIG. 10 represents functions executed in the course of a data access involving both a SDRP and an SDCP;

FIG. 11, including FIGS. 11 a, b, c, d, e, f, g, h, l, j, k, l and m represents functions executed in the course of performing a storage execution function by a SPID

### SUMMARY OF THE PRIMARY ELEMENTS OF THE INVISIDATA™ TECHNOLOGY

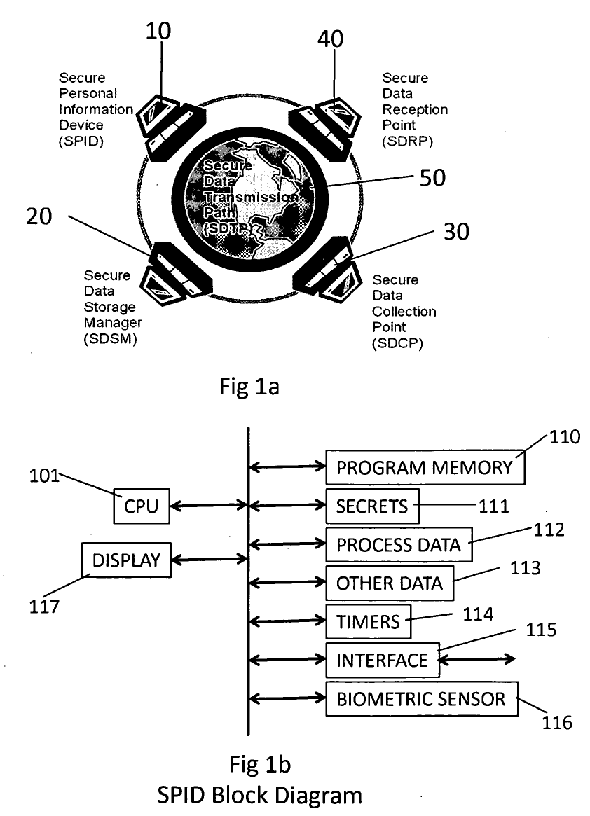

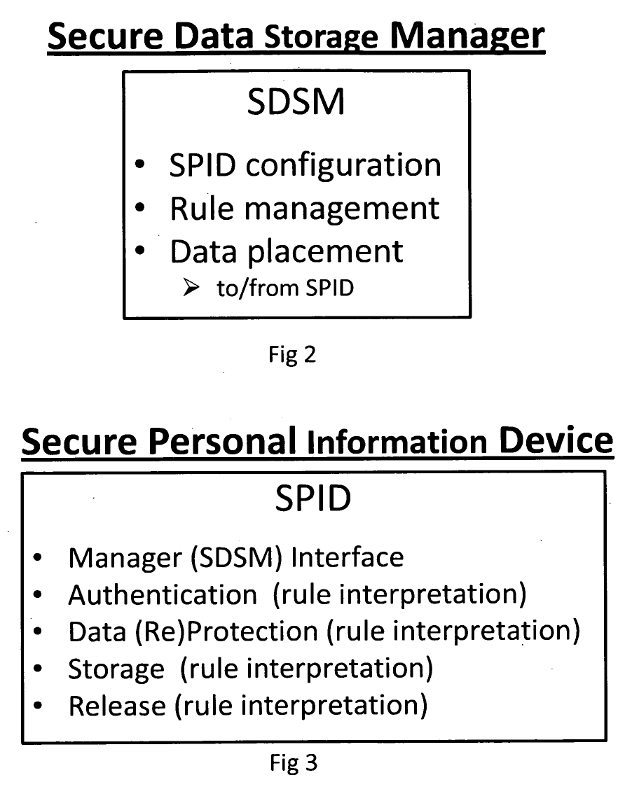

There are five primary elements to the most comprehensive form of the presently disclosed system (“InvisiData™”) as represented in FIG. 1a:
A Secure Personal Information Device (SPID) 10
A Secure Data Collection Point (SDCP) 30
A Secure Data Transmission Path (SDTP) 50
A Secure Data Reception Point (SDRP) 40
A Secure Data Storage Manager (SDSM) 20

### Secure Personal Information Device (SPID) 10

The Secure Personal Information Device (SPID) 10 is a hardware device (see the block diagram of FIG. 1b) designed to hold private information for the individual as well as any authentication data, security keys, protection mechanisms, etc. that the device might need to secure private data, secure data transfers and transactions, and prevent use of the transferred data for non-authorized transactions.

The private information can be any type of computer data such as, but not limited to personal data, images, documents, databases, audio, video, etc. Release of data from the SPID does not involve specific entry of information by its owner, simply a decisions as to which data to release and a biometric (fingerprint, DNA, voiceprint, etc.), password, challenge/response, and/or any other authentication method. The contents of the SPID, user selection, and authentication data are all invisible to any watchers and/or the user of the SPID. The SPID incorporates an appropriate biometric sensor.

The user selection of which data to release can be defaulted, automated, at the user's discretion, or manual. When a default is set, specific information, such as credit card information, is supplied during the data transfer process. If automated, a pre-specified set of choices and/or possible options is defined by the user in private. The SDSM, defined below, is typically used to establish defaults, automated, pre-specified and/or possible options, although SPID enabled devices can provide some or all of this functionality.

The SPID 10 incorporates authentication, key generation, key management, encryption, scrambling, and secure storage on a single hardware device. The device can be any combination of hardware and software elements sufficient to the task including, but not limited to, a single special purpose chip with embedded firmware and software incorporated into a portable and easily accessed tamper-proof carrier. The SPID combines scrambling and/or encryption and/or keying and/or hardware elements to protect the stored data “at rest” and during transactions. As shown in FIG. 1B the several components of the SPID 10 are coupled together by a bus 118 and include a SPU 101, program memory 110, a secrets memory 111, a process data memory 112, other data 113 one or more timers 114 and interface 115 and a biometric sensor 116. In addition, a optional display 117 is also illustrated, as optional it may not be present in all embodiments of the SPID 10. The particular parameters (speed, memory capacity, bit length, etc.) will be selected by those skilled in the art in accordance with the particular functions to be performed.

The SPID supports storage of separate access and protection rules for each piece of secured data in the single device. The SPID is capable of applying a non-mathematical process to allow for scrambling the data at the bit level rather than the BYTE, WORD, or field level, before encrypting it. The non-mathematical method of data scrambling utilizes a “shared secret” and provides a non-calculable yet reproducible method of obfuscation. Additionally, offsets into the “shared secret” can be negotiated by the SPID with its trading partner (such as another SPID, SDSM, SDCP or SDRP) to further randomize the scrambling. The SPID can implement a rolling ID for data transfer which is used to further restrict the potential for compromise, such as a playback attack. The rolling ID can also be utilized as a “salt” for encryption. Please note that “rolling ID” can be a sequential incremental number, number based on a known pattern, or any other method that both the SPID and the data recipient can both ascertain. Also, the “rolling ID” is also usable to prevent certain known exploits such as a “playback attack”. Expiration times may also be used in connection with ID and/or data transfers to further restrict the potential for compromise.

No private data is ever released by the SPID “in the clear”. There must always be an InvisiData™ enabled device, such as a SDSM or a SDCP, to process the data payload. The basic functions of the SPID are illustrated in FIG. 3. As shown, the SPID has a SDSM Interface Manager, Authentication function (to determine if the biometric sensor 116 represents an authentic user), data protection (basically data manipulation for purposes of hiding data, i.e., encryption and similar functions) and storage and release of data.

The SPID can be set to randomly decide which of several biometric and/or other authentications to request, for example, if the biometric device is a fingerprint reader, the device can randomly request one or more of the user's fingers in a random order, if so configured. The SPID optionally uses data hashing techniques such as, but not limited to SHA, SHA-1, MD5, etc., during various operations to further enhance validation that data is uncorrupted.

The SPID is a passive device in that it does not initiate information transfer. External elements communicate with the SPID requesting actions such as, but not limited to, storage and/or retrieval and/or deletion of owner-managed data. The private data contents of the SPID are determined by the information owner utilizing both InvisiData™ and other available technologies in combination with the SPID. The SPID can be embodied in many formats, including but not limited to credit card sized carriers, smart cards, PDAs, smart-phone chipsets, USB sticks, and memory cards, etc. See Section #6 for potential embodiments of the SPID.

When a request for SPID maintained data is made by an SDCP 30, the request can be configured to contain information about the interaction. For example, information such as the SDCP “owner”, encryption key, “salt” value, and/or the data destination can be part of the data request For embodiments of the SPID 10 that contain a display component, the device can be configured to display transaction information. In some embodiments, the SPID can be hard coded to display the “owner” and/or other transaction data. This information can be both persisted, stored, on the SPID and/or included in the data package being released by the SPID. This transaction data is subject to the same encryption/scrambling/obfuscation methods that is available to the SPID resident data being released by the SPID.

The SPID 10 can be configured to maintain a ‘list’ of multiple encryption methods, multiple keys/offsets/etc, and multiple obfuscations for use with a single trading partner. The SPID can be configured to maintain separate ‘list’ for use by different trading Partners. In addition, the SPID can be configured to share a list between different trading partners and/or groups within a trading partner. The SPID can also be configured to negotiate changes within these pre-established lists either during an active exchange or prior to data exchange for a specific transfer. This allows, among other things, for multiple encryption/scrambling methods to be used within a single InvisiData payload and/or data exchange packet with change-over(s) defined at bit boundary points.

The SPID 10 can be configured to generate one or more “alert/distress” data payloads. These payloads contains the defined alert along with the Unique Device Identifier (UDI) and, when appropriate, the Trusted Partner Device Identifier (TPDI). The TPDI is an identifier used by the Trusted Partner (TP) to identify the particular device/owner. The generation of the alert can be configured to be sent based on the authentication used for the device. For example, the left index finger fingerprint might be used for normal authentication while the right index finger fingerprint can be used to trigger an alert. It is the responsibility of the receiving device, such as the SDCP, to handle the alert. In addition to generating the alert, the SPID can be configured to permanently erase specific and/or all data based on the alert biometric.

The SPID 10 is configurable to allow for multiple, even unlimited, failed authentication attempts before going into “lock” mode. The lock mode prevents further usage of the device for a set period of time. The lock mode can be permanent or pseudo-permanent. Pseudo-permanent locking of the device is not time based and would required unlocking when coupled with a SDSM enable device. Permanent locking would render the device useless and would typically, but not always, be accompanied by the erasure of all information on the device and potentially the activation of “self-destruct” process which would damage the control processor and/or the storage.

The SPID can be initially configured to contain a complete list of all established TPs encryption keys, security protocols, and interaction protocols. In some embodiments, such as TP supplied single partner configurations, the list of established TPs information can be reduced or eliminated. In addition to the list of established TPs information, the SPID can be preconfigured to contain a list of encryption keys and obfuscation patterns The encryption keys and obfuscation pattern will be of varying types needed to support the different requirements of TPs, general usage and interaction with the SDSM.

### DESCRIPTION OF DIFFERENT SPID EMBODIMENTS

### Trusted Partner Supplied Secure Data Information Device (SPID) Initial State

In this embodiment, the SPID is pre-configured with information specific to the user for use with the trusted partner (TP), such as a bank. The SPID has a device identifier (TPDI) and user-specific data, such as bank account and credit/debit card numbers. The SPID also contains a unique and hardened (permanent) device identifier (UDI). The SPID is delivered in an inactive state and must be activated before use. It is important to note that the TP supplied SPID can be configured to either allow or prevent usage for data not tied to the device supplier. To accommodate additional data storage a device level encryption key (DLEK) is contained on the SPID. In this embodiment the DLEK is unique to the device. Other embodiments can have groups of devices utilizing the same DLEK, a random key from a group of DLEKs, an assigned key from a group of DLEKs, or no DLEK.

It is important to note that a single SPID can contain multiple TPDIs spanning multiple TPs. There can not be more then one TPDI for a specific TP. Although, a TP can choose to establish TP groups (TPGs) and/or additional TP identifiers to allow for multiple TPDIs. Each identifier and/or group can be configured to work the same or differently from the other groups. In the case of TPGs, in this embodiment there is one TPDI for the TP and each TPG has it's own TPG device identifier (TPGDI). In other embodiments the TPGDI can present but the parent TPDI utilized in the process or the TPGDI can be omitted.

The TPDI employs partner level encryption (PLE) using a standard encryption for the trusted partner. This level of encryption is in addition to the SPID device level encryption (DLE). It is important to note that in other embodiments the TPDI can be encrypted with any type and/or level of encryption or not encrypted at all as established by the TP. In addition, the TP can choose to omit the TPDI from the process. For example, if the user-specific data is encrypted utilizing a standard shared secret, or not encrypted at all, the TPDI is not required for the process. Although, the TPDI could still be used as a validation code, such as how the printed number on the back of a credit card is use. In this embodiment the TPDI is unique, but separate from the UDI. This allows the TP to issue a new device, to the same user, utilizing the same TPDI and user-specific data.

The user-specific data employs partner level encryption (PLE) using a unique shared secret This level of encryption is in addition to the SPID DLE. It is important to note that in other embodiments the user-specific data can be encrypted with any type and/or level of encryption or not encrypted at all as established by the TP.

The UDI employs manufacturer level encryption (MLE) using a specific encryption set by the manufacturer. This level of encryption is in addition to the SPID DLE. It is important to note that in other embodiments the UDI can be encrypted with any type and/or level of encryption or not encrypted at all as established by the manufacturer in conjunction with the TP.

To activate the SPID an activation code must be provided and a device security protocol (DSP) must be set. The activation code is supplied by the TP while the required DSP is set by the user. In other embodiments, an activation code might not be required and DSP can be set to none, one or more biometrics and/or access codes. For example, in implementations where the SPID is utilized on a shift basis, the SPID could be set to allow general use or accept the same biometric, such as a fingerprint, from multiple users.

A more detailed description of the SPID activation process for this embodiment;
The SPID contains a fingerprint reader (biometric sensor 116)
The SPID is connected to a SDSM enabled device, such as a PC.
The SDSM recognizes that an initial state SPID is connected to the system and starts the activation process
   The SDSM prompts the user for the activation code (or PIN) provided by the TP.
   The user enters the PIN, which was sent separately from the device
      If the wrong PIN is entered, the user is prompted to re-enter the PIN with an indication of the number of allowed attempts are left.
         If the attempt limit is reached without success, the SPID goes into a state that it can not be activated by the PIN and a new SPID needs to be issued.
      If the correct PIN is entered the SPID
         The SPID starts the activation process
   The SDSM prompts the user to configure and set the biometric authentication
      The configuration includes, but is not limited to;
         The number of fingerprints needed to activate the SPID and or the default release of the TP information. For example, the left thumb might be used to authenticate and then automatically release the TP data, such as CC information. While the left index finger is used to authenticate and allow for interaction with an SDSM.
      Once the authentication is set for the TP data, the SPID
      Uses the PIN to decrypt, the outer encryption envelope
         the TP data still has the DLEK and the TP level encryptions.
         Uses the configured biometric to encrypt the TP data
   Since this SPID can contain addition user data, the SDSM can then be used to enter and configure additional user data security and storage.

### General Use Secure Data Information Device (SPID) Initial State

In this embodiment, the SPID is obtained for general use with one or more TPs. The SPID is pre-configured with a TPDI and a UDI. The SPID is delivered in an inactive state and must be activated before use. To accommodate the addition of data, a DLEK is maintained on the SPID. In this embodiment the DLEK is a random key from a group of DLEKs. Other embodiments can have groups of devices utilizing the same DLEK, an assigned key from a group of DLEKs, a DLEK unique to the device, or no DLEK.

It is important to note that a single SPID can contain multiple TPDIs and TPGDIs spanning multiple TPs. There can not be more then one TPDI for a specific TP identifier. Although, a TP can choose to establish TP groups (TPGs) and/or additional TP identifiers to allow for multiple TPDIs. Each identifier and/or group can be configured to work the same or differently from the other groups. In the case of TPGs, in this embodiment there is one TPDI for the TP and each TGPTPG has it's own TPG device identifier (TPGDI). In other embodiments the TPGDI can present but the parent TPDI utilized in the process or the TPGDI can be omitted.

To activate the SPID an activation code must be provided and a device security protocol (DSP) must be set. The activation code is supplied by the manufacturer while the required DSP is set by the user. In other embodiments, an activation code might not be required and DSP can be set to none, one or more biometrics and/or access codes. For example, in implementations where the SPID is utilized to contain the medical information for an entire family, the SPID could be set to allow general use or accept the same biometric, such as a fingerprint, from multiple users. The SPID can be set to limit access to specific data based on the user (fingerprint). It is also possible to allow one user to access information of other users, such as a parent having access to child data while the child only has access to their own data.

### Adding TP Data to the SPID (Note: This if for the SPID. Further Description in SDSM)

In this embodiment, the SPID, either TP supplied or general usage, is being configured to contain data for a specific TP not currently stored on the device. The processes of adding, modifying and removing data from an SPID is controlled by the Secure Data Storage Manager (SDSM) which, in this embodiment, resides on a personal computer attached to the internet.

In this embodiment, the SDSM is configured not configured to auto-update the list of TPs. Using the SDSM, the user checks the local list of known TPs and discovers that the TP to be added is not on the list. The user then does a manual refresh of the TP list. Once completed the desired TP is on the list. The user then selects the desired TP and enters the required data. Once the user is satisfied that the data is correct the save to SPID process is started.

In this embodiment, the SPID is configure to handle and identify multiple users and is also configured to not allow the saving of data to the SPID unless proper authentication is done. The user, in this embodiment, authenticates using a fingerprint and the SDSM is able to store the data for their own use for the desired TP. The data stored includes, but is not limited to, the data the user wants to be saved and any/all security protocol data needed by the SPID to interact with the TP.

In this embodiment, the SDSM then passes the data, which has been encrypted using the TP's public encryption key to the SPID. The SPID then encrypts the data using a bio-metric enhanced key. The data is then encrypted a third time using an encryption and obfuscation pattern assigned to the device.

### Adding General Usage Data to the SPID

In this embodiment, the SPID, either TP supplied or general usage, is being configured to contain data for general usage. The user wants to have some medical information, dental x-rays, on the SPID that can be given to a new doctor.

### Emergency Use of the SPID

In this embodiment the user has setup “Emergency Medical Information” which contains, among other things, lists of doctors, current medication, chronic medical conditions. The data is stored using a known Emergency Medical encryption and obfuscation pattern when passed to the SPID from the SDSM. The SPID then encrypts the data using a bio-metric enhanced key. The data is then encrypted a third time using an encryption and obfuscation pattern assigned to the device.

In case of an emergency, a medical location, such as a hospital, which has been certified by LCTW Technologies Inc., has a SDSM configured for Emergency Medical retrieval.

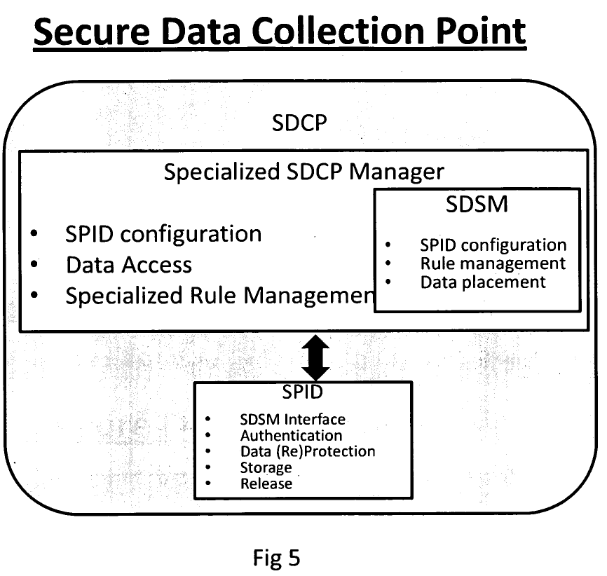

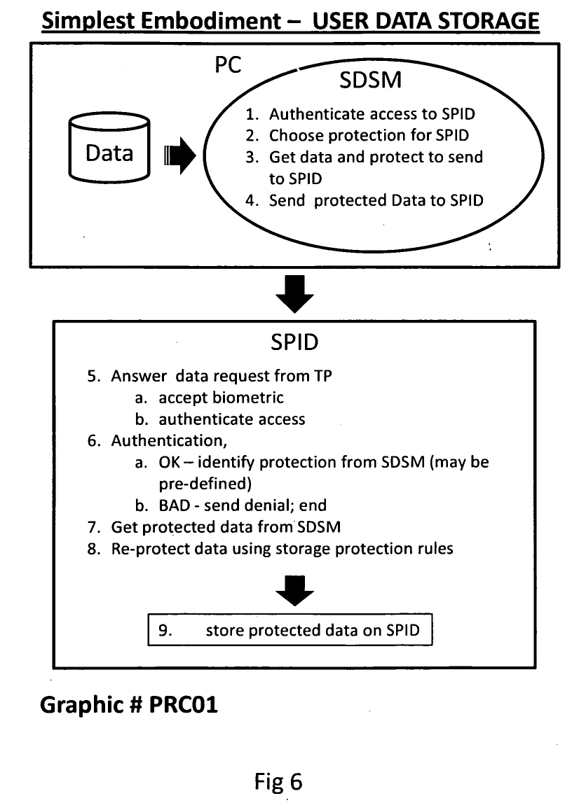

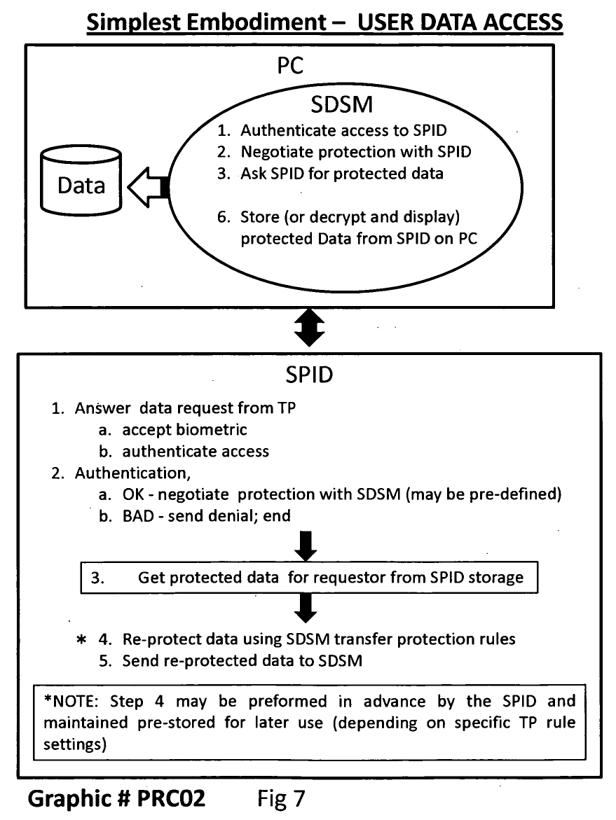

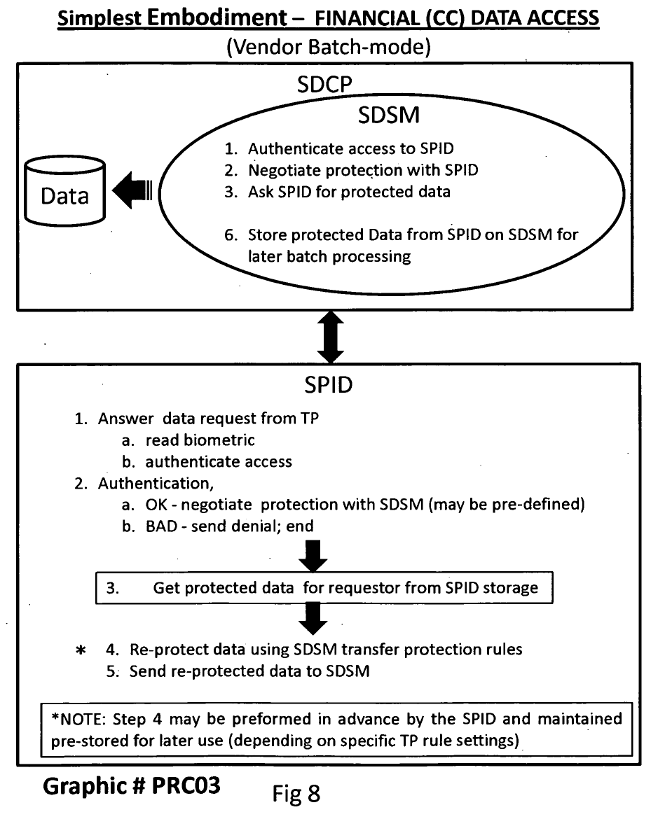

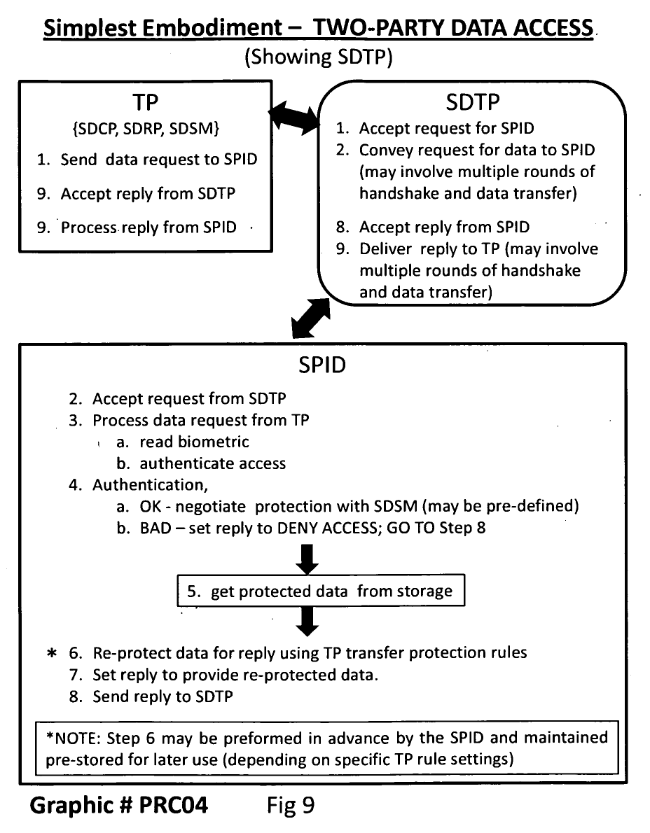

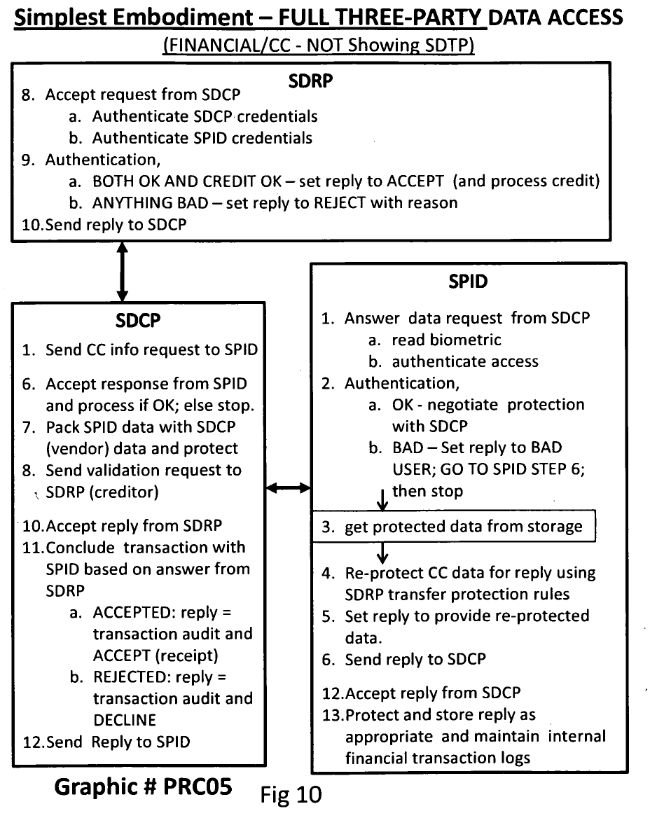

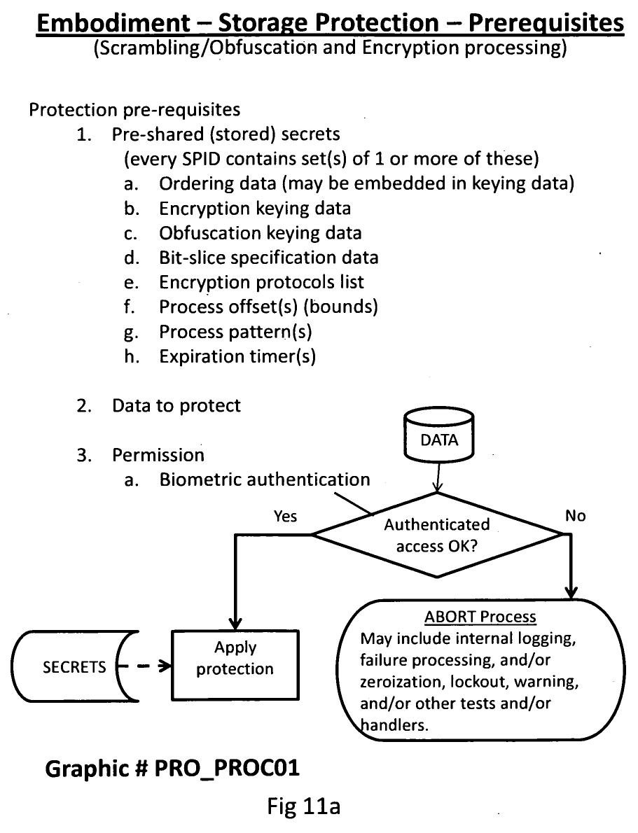

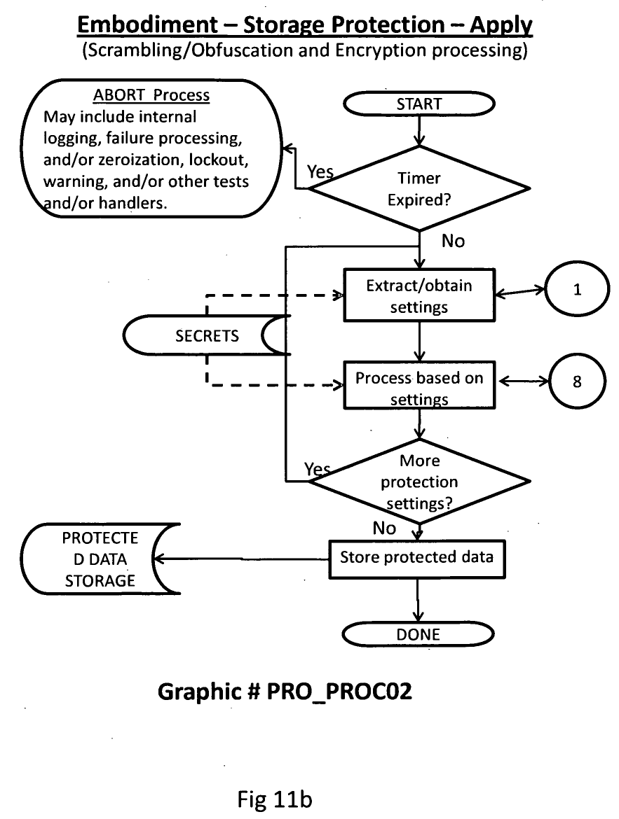

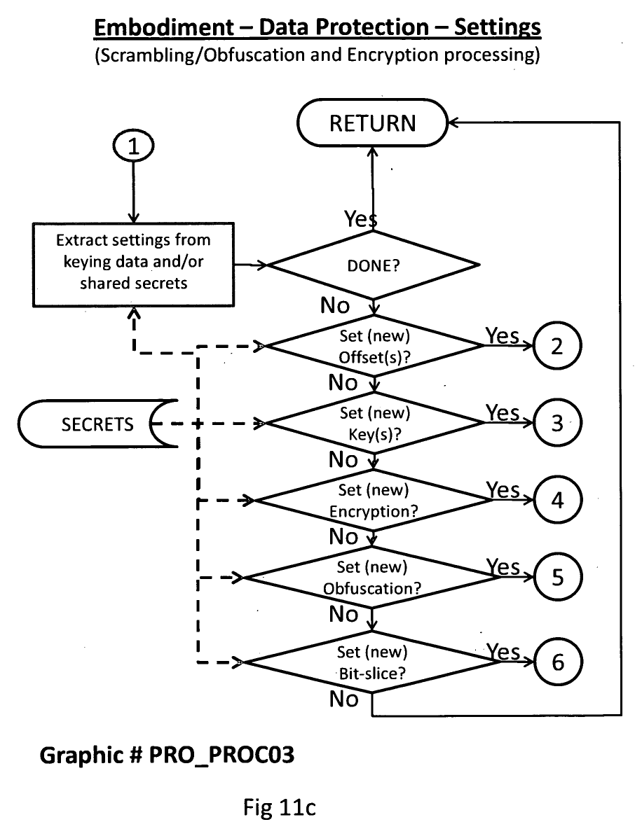

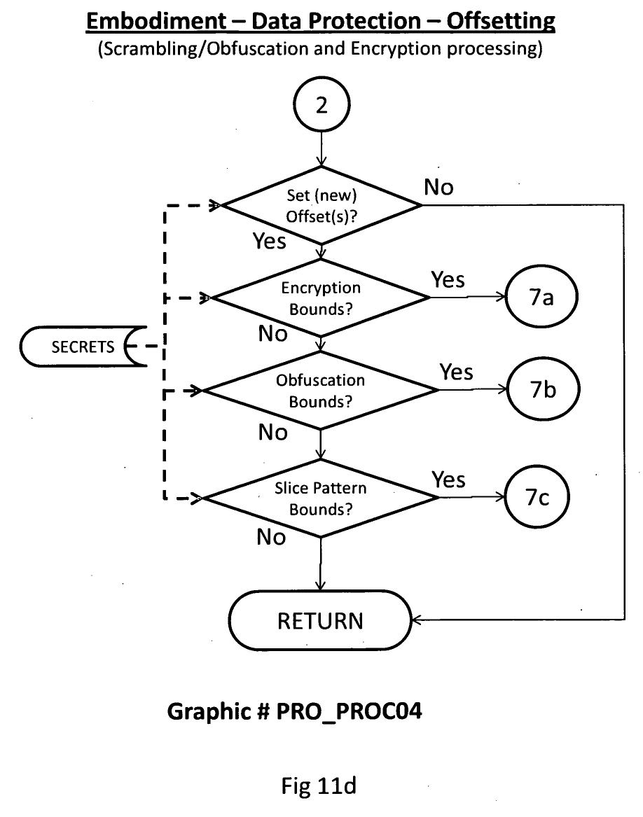

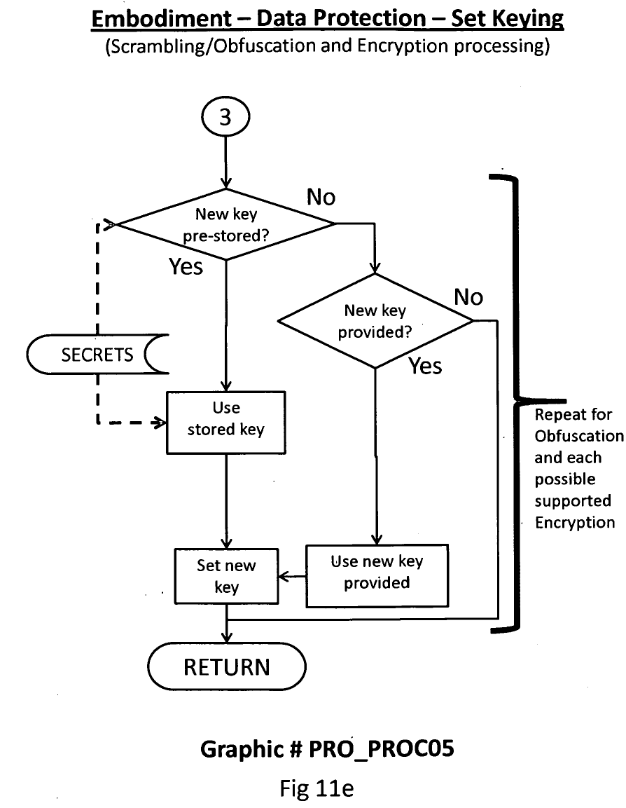

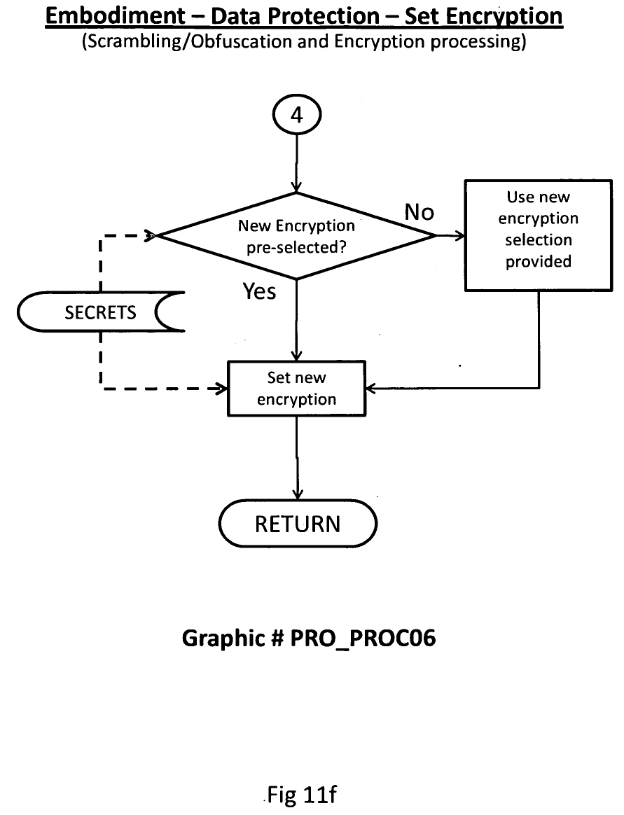

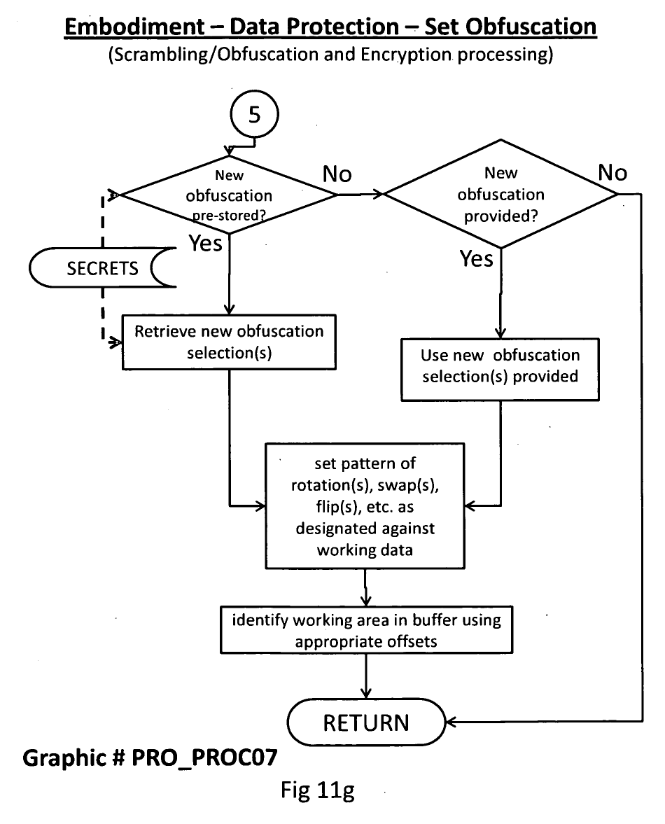

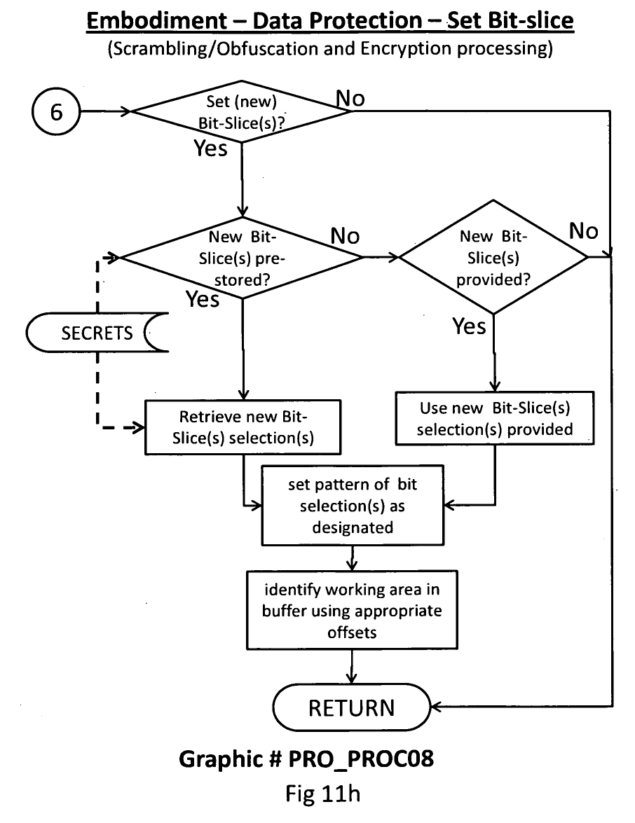

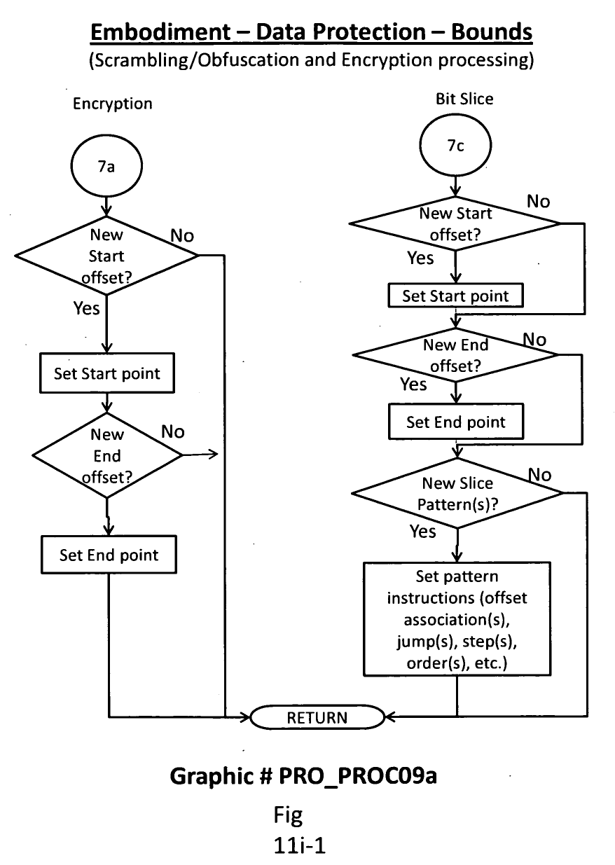

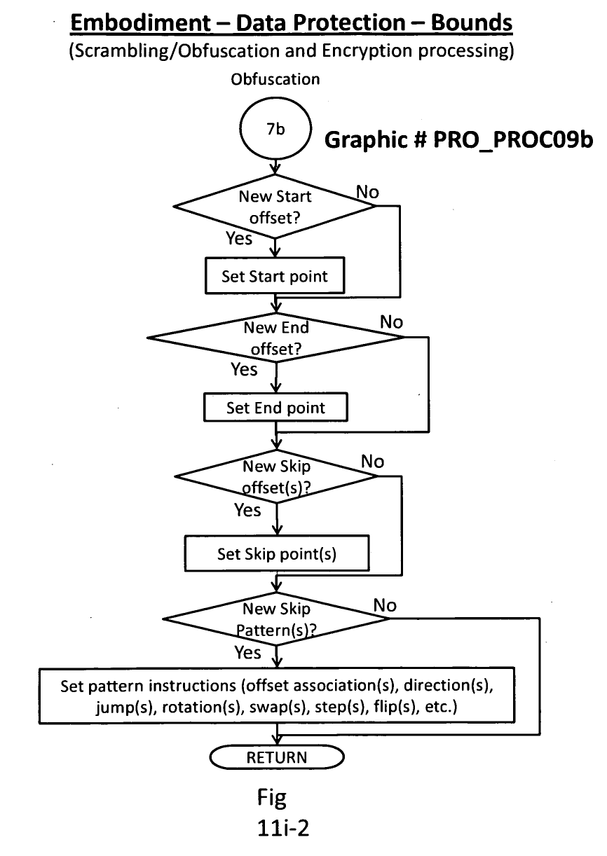

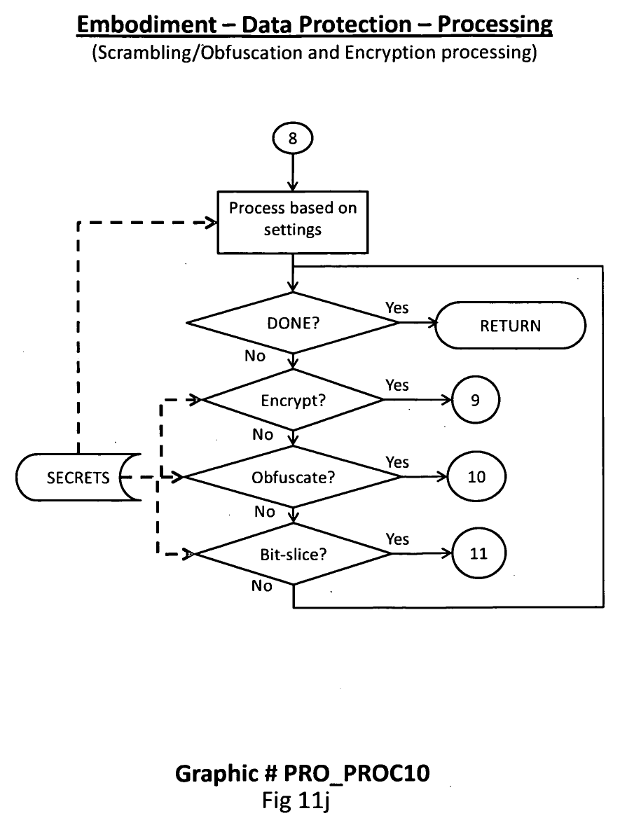

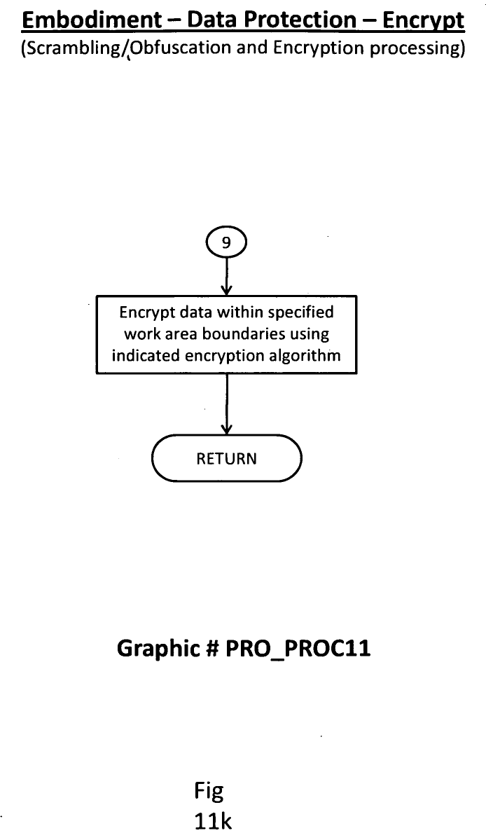

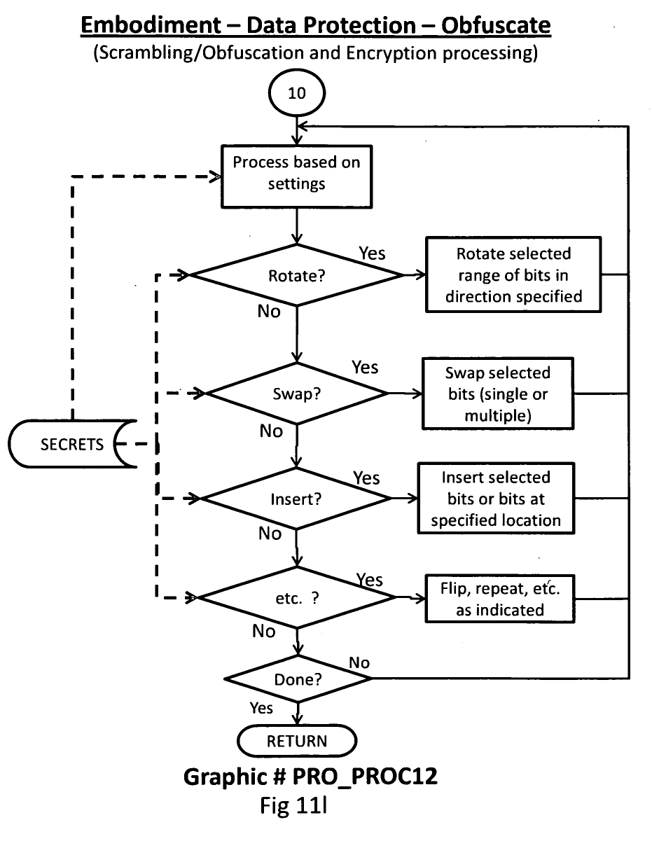

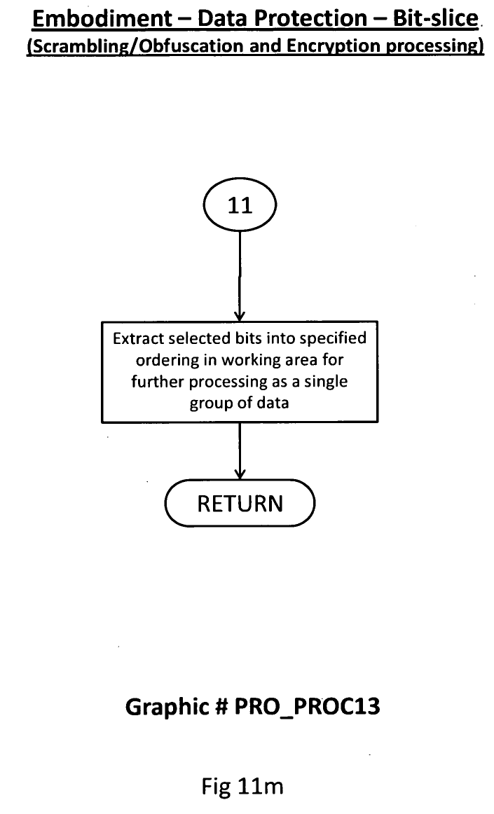

The Secure Data Collection Point (SDCP 30) is a hardware and/or software and/or firmware device designed to hold private information, authentication data, security keys, protection mechanisms, etc. for an un-trusted intermediate in a transaction (i.e. a system not under the control or supervision of the SPID and SDRP), such as a vendor or courier service, and whatever security keys and other data are needed to secure third-party data necessary to a transaction (vendor ID, delivery receipt, etc.). The InvisiData™ portion of the SDCP is tamper-proof. FIG. 5 is a basic block diagram of the SDCP 30. As seen the SDCP includes a SPID 10, an SDSM 20 and the SDCP Manager. The information from the SDCP is never exposed (e.g. is invisible) to the un-trusted user of the SPID and the SDCP itself. The information in the SDCP and any other transactional information entered by the user of the SDCP (amount of sale, physician's identifier, etc.) are often irrelevant to the SPID and/or the user of the SPID's purpose. The SDCP can be combined in a single device with other InvisiData™ technology, such as, but not limited to, an SDRP (below) and/or an SPID to operate concurrently with the functioning of the an SDCP (see embodiment #1 in section #6, below).

The SDCP 30 is tailored for use as an un-trusted intermediate. Optionally, the SDCP will also have one or more of the following distinguishing characteristics: An SDCP can be implemented to require only a single authentication for a pre-defined set time and/or multiple transactions such as but not limited to shift work, backup and recovery, bulk information transfer, etc.; in addition, the SDCP can have a knowledge of connectivity beyond the scope of an SPID such as but not limited to a set of pre-defined secure endpoints, intermediate un-trusted transfer medium, multiple authenticated users, etc.; the SDCP can also include the ability to create secure network tunnels on public and/or private networks; the SDCP can also have the ability to carry and deliver InvisiData™ data for a third party with or without introducing additional security to the data. These characteristics allow the SDCP to function as a commercial device such as, but not limited to, part of a point of sale (POS) terminal, an identification validator, an electronic courier envelope, etc.

The SDCP 30 is an active device in that it does initiate information transfer and function with regard to protection rules. The owner of the SDCP 30 initializes exchange information into the SDCP and sets its protection rules as appropriate. The possible protection rules include, but are not limited to, valid shift workers and/or clerks, access permissions and/or restrictions, etc. The possible exchange information includes, but is not limited to, merchant/physician ID, cost, diagnosis, identification authentication, patient prescriptions, and/or other use-pertinent information. When initiating communicating with a SPID 10, the SDCP 30 requests information as required while in it's functioning as the data exchange broker. The user of the SDCP 30 adds the exchange information, including but not limited to merchant/physician ID, cost, diagnosis, identification authentication and/or other information. The SDCP 30 then initiates a connection with the SDTP 50 (see below) to transfer the information to the target SDRP 40 or non-InvisiData intermediary. The SDCP 30 can be embodied as a system component in many formats, including but not limited to smart cards readers, POS terminals, PDAs, PC terminals, and/or web applications.

The SDCP 30 can be configured to maintain a ‘list’ of multiple encryption methods, multiple keys/offsets/etc, and multiple obfuscations for use with a single trading partner. In addition, the SDCP 30 supports standard communication protocols and encryption layer. The SDCP 30 can be configured to maintain separate ‘list’ for use by different trading Partners. In addition, the SDCP 30 can be configured to share a list between different trading partners and/or groups within a trading partner. The SDCP 30 can also be configured to negotiate changes within these pre-established lists either during an active exchange or prior to data exchange for a specific transfer. This allows, among other things, for multiple encryption/scrambling methods to be used within a single InvisiData payload and/or data exchange packet with change-over(s) defined at bit boundary points.

The SDCP 30 can be configured to propagate alert generated by a SPID 10 to any or all of the participants of the transaction (POS/SDCP operator, SDRP) or any external process or device, such as a silent alarm system. In addition, the SDCP can be configure to allow for multiple authorization attempts prior to propagating an alert to any or all of the partners.

### DESCRIPTION OF SDCP EMBODIMENTS

### Trusted Partner Supplied Secure Data Information Device (SPID) Initial State

In this embodiment, the SPID 10 is pre-configured with information specific to the user for use with the trusted partner (TP), such as a bank. The SPID 10 has a device identifier (TPDI) and user-specific data, such as bank account and credit/debit card numbers. The SPID also contains a unique and hardened (permanent) device identifier (UDI). The SPID 10 is delivered in an inactive state and must be activated before use. It is important to note that the TP supplied SPID 10 can be configured to either allow or prevent usage for data not tied to the device supplier. To accommodate additional data storage a device level encryption key (DLEK) is contained on the SPID. In this embodiment the DLEK is unique to the device. Other embodiments can have groups of devices utilizing the same DLEK, a random key from a group of DLEKs, an assigned key from a group of DLEKs, or no DLEK.

The Secure Data Transmission Path (SDTP 50) is a secure connection over existing network facilities that can use IPSec and/or proprietary technology to ensure that the transaction is inviolable during the actual transmission of all transaction data. This portion of the transaction is invisible to all parties related to the transaction and other observing parties. This step is detectable under certain circumstances but is secured using InvisiData™ protections applicable to data “in transit”. The SDTP is a trusted and/or un-trusted medium used for conveying private data, using InvisiData™ protections, that originated from an SPID, SDRP, or other InvisiData™ endpoint to it's intended InvisiData™ destination, including, but not limited to, an SDRP, SPID, or other InvisiData™ endpoint.

The SDTP is a passive device in that it does not initiate information transfer. The SDCP and/or SDRP initiates the use of the SDTP, manages the information moving into the SDTP and the SDRP and/or SDCP and/or SPID receives and decodes the information coming off the received via the SDTP. The SDTP can be embodied in many formats, including but not limited to public networks, telephone data or voice service, wireless data link, satellite data link, floppy disk, RS-232C, USB, S-100, CD-ROM, uuencoded printout later read by a character scanner, and/or other data transfer medium.

The Secure Data Reception Point (SDRP 40) is a hardware and/or software and/or firmware device designed to hold private information, authentication data, security keys, protection mechanisms, etc. for a trusted recipient in an “InvisiData™” transaction. The “InvisiData™” portion of the SDRP is tamper-proof. The SDRP 40 has the ability to recreate all the necessary pieces of the transaction for use at the final destination. The private keys from each device are invisible to the user of the SDRP 40 as is any other control and protocol information that may have been utilized by the SPID 10, SDCP 30, SDTP 50, and/or the SDRP 40, itself. An SDRP 40 can, if authorized, function as an SDCP as well, in the case of a financial transaction, with all the same levels of invisibility and privacy inherent in the SDCP. The SDRP can be any combination of “InvisiData™” technology associated with additional hardware and/or software for the purpose of accessing the “InvisiData™” for use by the intended recipient.

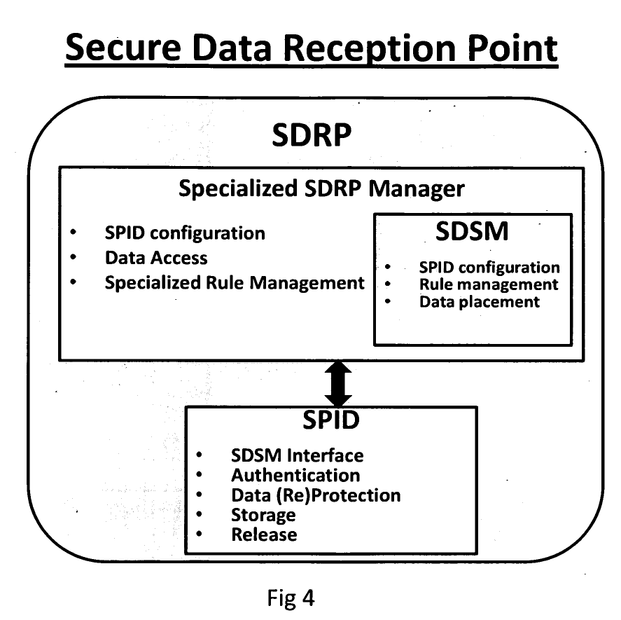

The SDRP 40 can be configured to process SPID generated alerts in multiple ways that include, but are not limited to, sending the alert to the SDCP, notify the operator of the SDRP, send the alert to a third part such as the police, any or all of the above. Additionally, the SDRP can be configured to disable the SPID due to one or more invalid attempts and/or alerts. A block diagram of the SDRP is found in FIG. 4. As seen there the SDRP includes both the SPID 10 and SDSM 20 as well as the SDRP Manager.

The SDRP may maintain a ‘list’ of multiple encryption methods, multiple keys/offsets/etc, and multiple obfuscations for use with a single trading partner and may negotiate changes within these pre-established lists either during an active exchange or prior to data exchange for a specific transfer. This allows, among other things, for multiple encryption/scrambling methods to be used within a single InvisiData payload and/or data exchange packet with change-over(s) defined at bit boundary points.

The Secure Data Storage Manager (SDSM 20) is an application designed to allow the owner and/or authorized user to store, retrieve, and/or manage an “InvisiData™” private data source (e.g. an SPID 10 and/or SDRP 40 and/or SDCP 30) and/or to configure an “InvisiData™” device for use and/or maintenance. The SDSM 20 allows the user to manage the data, device, access, authentication, logging, security and other functions on and “InvisiData™” device. The SDSM 20 allows the owner of an “InvisiData™” device to manage and specify all of, but not limited to, the following; role definition and visibility, role-based access, protection criteria, authentication requirements, authorized recipients, log management, etc. The SDSM 20 is also any combination of software and/or hardware whose purpose is and/or includes configuration, management, and/or control of “InvisiData™” technology. The SDSM 20 can connect to a data source and/or “InvisiData™” device using any SDTP supported by the specific embodiment of the other “InvisiData™” endpoint (note: in this context an external data file, such as but not limited to a backup file and/or any InvisiData protected data in any form, is considered an InvisiData™ endpoint). The SDSM 20 allows the SPID to be managed in many ways including, but not limited to, authentication initialization and rules, allowing the owner of the protected data to submit the data to the device for storage, retrieving data for review, specifying retrieval rules, configuring protection parameters, creating secure backups, creating relationships for information exchange, etc. The SDSM 20 allows an “InvisiData™” device to be managed in many ways including, but not limited to, specifying access rules, rules and settings for authentication and initialization, specifying retrieval rules, creating secure backups of the associated device, creating relationships for information exchange, specifying role protections, (for instance operators who are not permitted to see protected data—as in the case of POS clerks, couriers, etc.), configuring protection parameters, etc. The SDSM 20 does not have the ability to decode any third party protected data not owned and created by the authenticated user such as but not limited to, medical prescriptions on an SPID, trading partner semi-public keys on an SPID or SDCP, government authenticators on an SPID or SDCP or SDRP, customer data on an SDCP, etc. The managed element (SPID, SDCP, SDRP, or, under certain circumstances, the SDSM) is solely responsible for acquiring authorizations regarding the user attempting authentication and access for any actions requested by the SDSM.

The SDSM is an active device and/or element in that it does initiate information transfer to and/or from other “InvisiData™” elements and/or devices. It configures the elements and/or devices and manages the rights, roles and permissions for various data types under specific authorized and authenticated conditions, depending on the type of transaction and/or the nature of the device being configured. The SDSM can be embodied in many formats including, but not limited to, client software, host/server software, embedded chipsets in management devices, PDA devices, and/or web applications. See Section #6 for potential embodiments of the SDSM.

1. Summary of “InvisiData™” Scrambling Process

In addition to the primary “InvisiData™” elements there are four primary elements to the “InvisiData™” scrambling process, referred to as “obfuscation” and defined by this disclosure:

a. The original information to be scrambled, referred to as the “source data”

b. An arbitrary binary data segment, referred to as the “scrambler key”

c. An arbitrary data segment overlay pattern, referred to as the “scrambler pattern”

d. An optional offset into the data segment, referred to as the “scrambler offset”

The source data (SD) is any data that is to be scrambled using the obfuscation technique, such as but not limited to a document file, a text file, an image file, a group of files combined in a compressed archive, an encrypted file, a previously encrypted and/or scrambled file, etc.

The scrambler key (SK) is a binary data pattern derived from any source such as but not limited to a random number generator, a biometric identification pattern, a computer data file, etc. The SK can be any arbitrary length. The SK can be used in several ways to extend and/or obscure it's substance such as, but not limited to, a linearly wrapped key, a rebounding key, and/or a skipping key, where a linearly wrapped key repeats from the beginning once the end is reached, a rebounding key repeats by inverting the key when the end is reached and reverting to the original ordering upon reaching the beginning, and a skipping key discards key material according to a specified pattern. Other potential scrambling methods include, but are not limited to, inversion, inversion followed by XOR, patterned NAND against an indexed XOR, etc. The SK can be, but is not limited to, a pre-configured default and/or a configurable value.

The scrambler pattern (SP) is a logical data structure used to specify an operational overlay for the SK that determines how the SD will be scrambled. The SP indicates which bits in the SK are to be interpreted as instructions for the scrambling and how those bits are to be interpreted. Elements of the SP indicate how the SD is to be manipulated during the scrambling and unscrambling process and can include, but is not limited to, indicators for counters, offsets, replacement ordering, selection ordering, inversions, translations, transformations, logical operations (AND, NAND, OR, XOR, etc.), rebounding, wrapping, etc. The SP can also specify if the SP itself is to be used according to an SP rule set, such as but not limited to linear wrapping key, rebounding, skipping, inversions, translations, etc. The SP can be, but is not limited to, a pre-configured default and/or a configurable value. The SP values can be, but are not limited to, a pre-determined set of standardized reference values, a dynamically reassigned index into a pre-defined list, a real-time negotiated set of representative indicators, etc.

The scrambler offset (SO) is an optional element that may be used to specify an offset into the SK, SP, and/or, in some instances, the SD to be used as the starting point for application of the SP and/or SK. The SP can be, but is not limited to, a pre-configured default and/or configurable value. There can be many single and/or multiple purpose SOs and/or one global purpose SO used during the scrambling process.

See Section #7 for potential embodiments of the “InvisiData™” scrambling process.

### POTENTIAL EMBODIMENTS OF THE “INVISIDATA™” ELEMENTS

This section outlines some of the potential embodiments of the “InvisiData™” elements as related to the “InvisiData™” technology. This does not limit the use of the “InvisiData™” technology, but more clearly identifies many of the ways in which the “InvisiData™” technology can and/or will be utilized. In several instances below, additional steps are outlined that could be omitted, but provide an example of possible additional important functionality. Much of the general functionality defined for the “InvisiData™” elements in the embodiments below can be incorporated into larger multi-purpose implementations and it is understood that these examples are in no way an exhaustive list of embodiments and interactions possible for the “InvisiData™” technology.

### DESCRIPTION OF PREFERRED PROCESS EMBODIMENTS

### Embodiment #1

### Financial Transaction at Real-Time POS with Credit-Card Sized SPID

In this embodiment the SPID is a tamper-proof credit-card sized carrier with an embedded chip and interface capable of communicating with a point of sale (POS) device that contains an embedded SDCP. The “InvisiData™” enabled POS device (SDCP) will be activated at the end of a sales transaction. The purchaser inserts the SPID into the SDCP's “InvisiData™” enabled card reader. In this embodiment the card reader is a USB 2.0 interface. In other embodiments the card read can be from, but is not limited to the following; proprietary card reader, generic card reader such as DRAM, wireless technology such as Bluetooth, magnetic strip reader, active transponder, or any other interface currently known or unknown.

The SDCP then attempts to recognize whether it is a SPID device. If it is a non-SPID credit card the SDCP then processes the transaction using alternate standard methods, if appropriate. When the SDCP identifies a SPID, an “InvisiData™” enabled credit-card, the SDCP requests the appropriate payment information from the SPID, as follows:
The SDCP request data from the SPID.
The SPID recognizes the request and challenges the user for proper authentication. In other embodiments the SPID can recognize the request and act as, but is not limited to, the following; wait a pre-defined period for proper authentication, wait indefinitely for proper authentication, continue only if authentication is ready for processing, etc.
   If authentication fails, an alert would be presented to the SDCP.
      In this embodiment, the SPID is configured to allow two additional authorization attempts, or a total of three attempts, before the device goes into a 30 minute “lock-down” period. The SDCP is configured to prompt the operator to ask for picture ID of customer after the second failed attempt. After the third attempt the SDCP is configure to send a failed authentication record to the SDRP, an instant message to the “manager's terminal”, and a message/code to the operator to ask the customer for another form of payment.
   If the authentication succeeded using an alert/duress authorization, an alert is presented to the SDCP.
      In this embodiment, the SDCP is configured to send a user in distress authentication record to the SDRP, an instant message to the “manager's terminal” indicating the problem, trigger a silent alarm automatically and a message/code is presented to the operator to delay the customer as long as possible.
If authentication succeeds normally, the SPID, prepares the data, as configured, for transfer to the SDCP.
The SPID then presents, scrambled and encrypted, an account owner identifier, the TPDI, along with a “public” ID index, the user-specific data, and a hash of the user-specific data to the SDCP.
   Note: The “public” ID is a non-private customer identifier encrypted using the credit company/bank's public key and standard encryption.
   Note: The scramble and encryption for this TP utilizes a number imbedded in the data. The number identifies a relative transaction number between the SPID and the TP. This is used to protect against playback attacks. The number is also used as “salt” for the encryption of the user-specific data.
   Note: The hash is used to verify that the information from the SPID has not been tampered with.
The SDCP device prepares the SPID presented data along with the purchase information and vendor's data. The prepared data is based on the configurations established by the SDCP/SDSM's owner at the SDCP configuration site.
The SDCP then further scrambles and encrypts the transaction and transfers this information to the SDTP for routing to the TP, in this case a credit company/bank.
The TP's SDRP receives the data payload, transaction, an prepares to access it.
The SDRP unscrambles and decrypts each parties information using the non-private IDs, and passes the actual transaction to the SDRP's local SDSM for processing.
The SDSM interfaces with the TP's local systems to further decrypt the data payload as needed. The TP then processes the transaction.
Once the processing is complete, the TP's local system communicates with it's SDSM to begin a response to the initiating SDCP. In this embodiment the process is “statefull” and the SDCP will not “complete” the transaction until a response from the SDRP is received. Please note that the SDRP's SDSM utilizes the SDRP in a manner identical, in this embodiment, to the function of SDCP. The SDRP scrambles and encrypts the appropriate transaction data and routes it over the SDTP to the SDCP at the POS, acting as a SDRP, site with the appropriate processing message.
The SDCP then decrypts the data payload and processes as configured.
   If the transaction was allowed, this embodiment sends the transaction data to the SPID for reference storage. This embodiment has the transaction information stored using third party TP encryption for eventual retrieval by “trusted” accounting software. It is important to note, the SPID can be configured to store the transaction data utilizing only owner and SPID protection mechanisms for later retrieval by pseudo-trusted user. For example, the SPID owner can transfer the data to a local system, with the proper authentication, for use by a stand alone application, such as Quicken. The SDCP also stores the transaction information as a transaction record. A one-way hash is used to convert the encrypted customer ID into a format usable by the POS/SDCP for storage by the local system. It is important to note that alternate hashes or no hash can be used.
   If the transaction is rejected, in this embodiment the SDCP processes the transaction as configured by presenting the reject code to the operator of the SDCP/POS device and propagating the transaction information to the SPID.

### Embodiment #2

### Financial Transaction Using a Web-Site and “Digital Wallet”

The SPID would be a tamper-proof chipset protecting an internal and/or external data storage device such as, but not limited to, a USB disk-drive, a memory stick, and/or other permanent or removable storage device, functioning as a “digital wallet”. The computer accesses a website that is “InvisiData™” enabled. The enabled site would request access to the “digital wallet”, which would be connected if implemented as an external or removable device and hard-wired if an internal pre-connected device. The website and it's purchase transaction web page, acting together as an SDCP, would request the needed data and await correct authentication by the user at the SPID. The SDCP would then coordinate transfer of the necessary transaction information to the web-site server's portion of the SDCP using the SDTP. The appropriate information is added to the transaction and the site's SDCP will scramble and encrypt the final transaction and transfer that information via SDTP to the credit card company/bank site for approval. The SDRP at the credit card company/bank site will receive the transferred information to unscramble and decrypt the transaction for approval. Once the processing is complete, the SDRP uses it's SPID and/or SPID functionality to scramble and encrypt the appropriate transaction data. The SDRP then routes the reply data via SDTP to the SDCP at the web vendor's server with the appropriate allow or deny message. If allowed, and based on rules and permissions configured at the site or by the original SPID owner, the transaction data is sent on to the SPID in the “digital wallet” for reference storage and/or logging (which can be retrieved by the owner later for accounting, tax, or other reference purposes).

### Embodiment #3

### Financial Transaction Using a Cellular Phone with Web Browser

The SPID would be a single tamper-proof chip inside a cellular phone with Internet web browsing capability. During a data session, the phone's owner will access an InvisiData™-enabled web-site to generate an internet order from a restaurant for dinner delivery. Once the order is completed, the web-site will request payment information from the SPID. The SPID will request a voiceprint for validation (and/or other means of authentication) using the embedded authentication technology. The “InvisiData™” chipset will then function as an SDCP and will scramble and encrypt the transaction and transfer the information for routing by SDTP to another intermediary SDCP at the server where the web-site is housed. Note that in other embodiments the intermediary site does not have to be a SDCP. At this point, the transaction will be processed as in Embodiment #2 above with the following changes: If authentication failed, an alert would be presented to the SDCP on the website and the purchase refused. If the authentication fails using a pre-defined alert/duress indication, the SDCP would trigger an appropriate alarm automatically such as, but not limited to, contacting authorities with the cell phone's identifying device data, transparently provided by the SPID as part of the transaction, and allowing the purchaser to be located via the cell phone.

### Embodiment #4

### Financial Transaction at POS Terminal in “Batch Mode”

For those cases where the POS terminal is not able to operate interactively with credit card issuer, the SDCP would function in a “batch mode”. The SDCP would collect multiple purchaser data transactions over a period of time. The SDCP would typically be configured to provide a “receipt” for the data transfer. For each transaction, the SDCP would request a bank-specific ID from the SPID that validates the purchaser as a legal owner of a legitimate, unexpired credit-card or bank account. When the SDCP is made aware of a valid SDTP, the collected transactions would be forwarded for validation at that time. It would then function as demonstrated in Embodiment #1 above with the exception that since the SPID will no longer be available when the approval process is executed, the SDCP may send an ‘un-validated’ receipt to the SPID or may not send any results of the transaction back to the SPID. Also the following changes apply: If authentication failed, an alert would be presented to the SDCP operator and the purchase refused. If the authentication succeeded using a pre-defined alert/duress indication, the SDCP would trigger an appropriate silent alarm automatically, such as, but not limited to, alerting the vendor's security guards. The SDCP is configurable to allow for the prevention of obtaining data for unsupported transaction partners. For example, if a restaurant only takes the American Express card, the SDCP can be configured to only accept data for AMEX transactions. If the data from the SPID is for, say, Discover Card, the SDCP will reject the transaction.

### Embodiment #5

### User Management of Financial Information at SPID

The SDSM in this embodiment could be a web-based software tool used by a credit-card issuer to install a purchaser's account access on the purchaser's SPID, which already holds other personal user information. The SDSM would create a secure connection, potentially using a secret key pre-loaded on the SPID/SDCP/SDRP, with the issuer's computer and obtain an issuer-specific authorization key for later use in non-networked transactions (batch mode) and a user-specific account authentication. The SDSM would then broker the creation of shared secret (symmetric) and/or public-private (asymmetric) keys required for communication with the issuer. These data would be presented to the SPID by the SDSM for scrambling, encryption, and storage as reference data and primary identifiers for an accessible credit-card for the purchaser, locked to the purchaser's SPID biometric and/or other authentications (in this case a SPID-read fingerprint and a use-time display of the user's face given to the SDCP during the purchase transaction).

### Embodiment #6

### Institution Management of Financial Information at SDRP

One SDSM in this embodiment could be a software tool used by a credit-card issuer to secure purchaser's account information on the purchaser's single-purpose SPID prior to delivery to the purchaser. The SDSM would, on creating a new purchaser account, set the SPID to require that the appropriate identification and authentication information be initialized prior to the first time the purchaser uses his SPID. In this embodiment, the first time the buyer attempts to use the SPID to make a purchase, the financial SDSM would request that the individual's appropriate authentication information be forwarded to the SDRP and the SPID would indicate that the POS operator at the SDCP instruct the purchaser to enter his SPID activation using the POS' credit-card keypad and initialize his authentication to the SPID, when prompted. The buyer's SPID would then release the appropriate information, within a separate and secure transaction, at the SDCP which would forward the information to the SDRP for storage using the SDSM in the financial institution's system. The SDSM would then broker the creation of shared secret (symmetric) and/or public-private (asymmetric) keys required for future communication with the buyer's SPID. This data would be presented to the SDSM for scrambling, encryption, and storage with the buyer's record in the institution's data records. This data would only be accessible upon proper authentication with the buyer's SPID over SDTP during authenticated purchasing transactions and would be invisible to any humans while stored in the institution's database or during transit of a given transaction. The purchase transaction would then be processed in a manner similar to Embodiment #1. The automated purchase-time initialization, occurring almost entirely transparently to the purchaser and clerk, would not significantly impact the entire elapsed time for the purchase.

### Embodiment #7

### Sample Medical Examination Requiring Real-Time Record Review

The SDRP could be, but is not limited to being, a stand-alone diagnostic terminal at an emergency medical facility. This can be a computer station, imager, and/or third party system containing the appropriate software and/or other specialized display or output tools to allow a medical professional to access and review medical information from a patient. The patient would arrive for the consultation. At that time, the physician's SPID would be inserted in order to open the institution's record for the patient along with all necessary information to audit any activity done during the patient's session. Once the physician has been successfully authenticated, the SDRP would store the relevant session information which would include one or more of two types of time-limited, renewable, medical authorization keys provided by their licensing agency or employer. The first key type is a generic key for medical institutions and the second key type is specific to that institution. The patient's SPID would then be connected to the SDRP and the patient would authorize release of the appropriate medical records using one or more of the generic or specific keys. The patient's SPID would hold a generic decryption key that the SPID may also use. To have the specific key for that institution, the SPID owner would have to previously configure their SPID for that institution. The specific key for the institution would be a secret key maintained by a central authority. The SDRP would then unscramble and decrypt the “InvisiData™” formatted record and forward the appropriately formatted record to the appropriate software and/or specialized display or output tool. Please note that the SPID could also download the institution specific key from the SDRP.

### Embodiment #8

### Alternate Medical Examination Requiring Emergency Record Review

The specific information and authentication exchanges can vary greatly depending on the specific application(s) addressed. This embodiment includes, but is not limited to, some of those variations and is intended to make clear the existence of multiple application-specific and standards-specific constraints that the InvisiData™ technology is intended to accommodate.

The SDRP could, as in Embodiment #7, be a stand-alone diagnostic terminal at an emergency medical facility. The patient would arrive for a consultation, insert their SPID in the examination-room access port, and faint before being able to authenticate for medical records access. At that time, the physician's SPID would be inserted into a second access port, and authenticated in order to open the office's records for the patient along with all necessary information to audit any activity done during the doctor-patient session. Once the physician has been successfully authenticated as a licensed physician using the office's medical credential SPID, the office's SDRP would request the relevant patient information from the patient's SPID. The patient's SPID would also hold a generic secret emergency medical record encryption key that it can use as an encryptor for transferring copies of medical information. The doctor would tell the SDRP to obtain all recent medical data from the patient's SPID using the emergency authenticating encryption data necessary to create data readable under the doctor's authentication. The “medical override” would be logged to the two SPIDs involved in the transaction and also via a WAN SDTP to an emergency medical logging SDRP. The doctor's SDRP would then unscramble and decrypt the “InvisiData™” formatted record and forward the appropriately formatted record to the appropriate software and/or specialized display or output tool for review. This entire validation and override process would occur within seconds, and expedite the doctor's access to the pertinent patient data.

### Embodiment #9

### Medical Examination Requiring Real-Time Record Updates

The SDRP is set up as described in embodiment #7. Once the patient's review is complete, the physician makes some updates to the patient record. At that time, the SDRP will function as an SPID authenticating against the current session information and/or using the physician's SPID and appropriate authentication. The patient's records would then be protected using the method and/or keys published by the central authority. The data would also have been protected by the doctor's SDRP and transferred back to the patient's SPID, in essence functioning as an SDSM for the patient's SPID.

### Embodiment #10

### Medical Record Transfer Between Facilities

A medical records SDSM receives a digital medical record file that includes, but is not limited to, physician notes, lab records, test results, digital images, etc. The SDSM scrambles and/or encrypts the medical record and provides it for storage in a file on the medical records computer. Upon receiving a valid request from a participating institution, a medical records technician requests the specified record from the SDSM using the technician's personal SPID. This process is discussed in Embodiment #7 and Embodiment #8. Once authentication is complete and the record has been retrieved, the technician's SDRP/SDSM performs the necessary re-securing of the data for the requesting institution thus allowing the requesting institution to unscramble and decrypt the record. The SDRP/SDSM then uses an SDTP to route the record to the requesting institution. The requesting institution uses their SDRP to receive the record from the SDTP and proceeds to unscramble and/or decrypt the medical record. The SDSM at the requesting institution then scrambles and/or encrypts the medical record into a file on their medical records computer using their office's practice-specific keys and rules, and then notifies the requesting physician that the record has been received and is available for retrieval.

### Embodiment #11

### Medical Record Transfer in Emergency Situations

The SPID that contains medical records will also be entrusted with an “emergency unlock” that will be activated only with the use of an authenticated emergency SPID device. For example: the patient is found unconscious at the scene of an auto-accident. The first responder (in this example a member of the local police or fire department) places an emergency call for an EMT and then connects their SPID to the portable first responder SDRP. After authentication, the appropriate information regarding the first responder is stored in the SDRP for the duration of the session and/or logged for reference. The first responder also locates and connects the patient's SPID to the SDRP. After the SDRP automatically sends the emergency unlock code tagged as a first-responder, an emergency unlock audit record is written on the patient's SPID for later retrieval by the patient when connected to an authorized SDSM. Similar logging information is also secured in the first responder SDRP as a legal record. The first responder is able to view limited pertinent information such as, but not limited to name, address, emergency contact information, physician information, current medications, medic alert information, etc. At this time, the request for an EMT is supplemented electronically by the SDRP and automatically transmitted via SDTP to the assigned EMT's SDRP. In this way they are forearmed with necessary potentially life-saving data while still en-route. Before arrival at the scene, the EMT connects their personal EMT SPID, and authenticates for session access, for using their portable EMT SDRP. Upon arrival at the scene, the appropriate information regarding the EMT, first responder, and patient can be exchanged with the first-responder's unit using a SDTP through an automatically established wireless link and stored in the appropriate data logged to and stored in the EMT SDRP for use. The process also creates and appropriately stores another emergency unlock audit record. Since the EMT authentication is tagged as an emergency medical professional the EMT SPID, using the first-responder's SPID as an SDCP/SDSM, is also able to unlock detailed medical records facilitating proper treatment of the unconscious patient. The EMT updates the medical records with any additional medical data generated during the course of emergency treatment, and locates the patient's SPID to ensure transport with the patient to the nearest medical institution.

### Embodiment #12

### Medical Record Transfer without Electronic SDTP Availability

The SDSM receives a digital medical record file that includes, but is not limited to, physician notes, lab records, test results and/or digital images. The SDSM then scrambles and encrypts the medical record in a file on the medical records computer. When needed, the medical records technician requests a printout of the medical record in “InvisiData™” format. The SDSM converts the “InvisiData™” from a binary file to an alphanumeric printout utilizing the uuencode process. The technician forwards the printout to the physician via ‘Federal Express’ overnight mail. The physician uses a portable OCR scanner, uudecode software, and his laptop to reproduce the “InvisiData™” format file onto his local computer. The physician then connects a portable SDRP and requests the medical record. The SDRP unscrambles and decrypts the medical record and sends the information to the appropriate application for viewing.

### Embodiment #13

### Government-Issued Identification

The SDSM, in this embodiment, would be a generic SPID data management software package running on the user's PC. The user retrieves their general owner information data from the SPID and enters a change of address and an additional phone number for themself. The SPID embodiment in this example is designed to present this owner information along with any government-issued identification stored on the SPID whenever requested by a government-related transaction, such as but not limited to passport use, driver's license check, social security benefit transaction, etc. Note that in no way is the associated government-issued data altered in this example. The presumption is that the owner information would be checked as part of the government-related activity, such as but not limited to a police officer verifying last known address during a traffic stop. Please note that in this embodiment, the SPID will create an audit record for all identification requests that contains the requesting entity, a date/time stamp, location, individual requestor ID. Such records may be implemented as indelible, once created, to support use as unimpeachable legal evidence.

### Embodiment #14

### Personal Data Storage Needs

The SDSM, in this embodiment, would be an “InvisiData™” enabled data management software package running on the user's PC. The SDSM would provide data access and modification capability on the PC upon SPID authentication of the user. The SDSM would also provide configuration capabilities, such as but not limited to allowing building access rules to be associated with an “InvisiData™” house-key functionality, and/or spending restrictions associated with a configured credit-card, and/or an alternate authenticator for a ‘silent-alarm’ function (when the SPID owner is under duress during use—as during a robbery), and/or account selection rules used to speed transactions during spending via credit account and/or bank debit, etc. A secondary authentication may be required when transferring the information that is stored by the SDSM to the SPID for transport, installation, and/or usage.

### Embodiment #15

### Passive Financial Transaction at POS Terminal in “Wireless Batch Mode”

For those cases where the POS terminal is not able to operate in real-time and supports WiFi, Bluetooth and/or other interactive wireless communication or passive wireless receiver, the SDCP would function in a “batch mode”. The SDCP would collect multiple purchaser data transactions over a period of time. For each transaction, the SDCP would detect a bank-specific ID, available from the SPID, for example but not limited to via a passive RFID emulator, that validates the purchaser as a legal owner of a specific credit-card or bank account. Later the SDCP uses a valid SDTP and the transactions to date would be forwarded for validation at that time. The SDCP would then function as demonstrated in Embodiment #1 above with the exception that since the SPID will no longer be available when the approval process is executed, the SDCP would not send any results of the transaction back to the SPID when the SDRP is contacted.

### Embodiment #16

### Active Financial Transaction at POS Terminal in “Wireless Batch Mode”

For those cases where the POS terminal is not able to operate in real-time and supports WiFi, Bluetooth and/or other interactive wireless communication and/or passive wireless receiver, the SDCP would function in a “batch mode”. The SDCP would collect multiple purchaser data transactions over a period of time. For each transaction, the SDCP would request the purchaser information from the SPID (in a manner similar to that described in Embodiment #1) which would contain a bank-specific ID that validates the purchaser as a legal owner of a credit-card or bank account. Later, the SDCP uses a valid SDTP and the transactions to date would be forwarded for validation at that time. It would then continue to function as demonstrated in Embodiment #1 above with the exception that since the SPID will no longer be available when the approval process is executed, the SDCP would not send any results of the transaction back to the SPID when the SDRP is contacted. However, at transaction time, the SDCP would send the usual data to the SPID but include a data tag indicating that the bank validation may still be pending.

### Embodiment #17

### Financial Transaction at POS Terminal in “Wireless Interactive Mode”

For those cases where the POS terminal is able to operate in real-time and supports WiFi, Bluetooth, and/or other interactive wireless communication, the SDCP would then function as demonstrated in Embodiment #1 above using a wireless SDTP to the purchaser's SPID.

### Embodiment #18

### Financial Transaction at POS Terminal in “Transponder Mode”

For those cases where the POS terminal is not able to operate in real-time and supports UHF RFID and/or other passive wireless communication and/or passive transponder, the SDCP would function in a “batch mode”. The SDCP would collect multiple purchaser data transactions over a period of time. For each transaction, the SDCP would detect a bank-specific ID attached to the secured and protected user-to-bank identifiers and/or authenticators and/or any other relevant required data, available from the SPID via a passive RFID emulator and/or specialized passive RFID transponder, that validates the purchaser as a legal owner of a specific credit-card or bank account. The purchaser's SPID would only function in this mode and be able to release data while actively obtaining proper authentication, such as but not limited to the purchaser pressing a fingerprint identification pad on the SPID. Later, when the SDCP uses a valid SDTP, the transactions to date would then be forwarded for validation by the bank. It would then function as demonstrated in Embodiment #1 above with the exception that since the SPID will no longer be available when the approval process is executed, the SDCP would not send any results of the transaction back to the SPID.

The following portion of the specification describes several different techniques for obfuscation. An important advance in the fields of hiding data (such as commonly referred to as encryption or the like) is implemented by applying more than one encryption algorithm or process to a single data object. This can be implemented by using two different encryption algorithms or processes or more than two encryption algorithms. Preferably the two or more encryption algorithms are each applied to a unique subset of the data object such that, for example, encryption algorithm one is applied to a first subset of the data object whereas encryption algorithm two is applied to a distinctly different subset of the data object. It will be apparent that other and different encryption algorithms can be applied to still different subsets of the data object.

Enhanced protection is obtained by then “mixing” the results of the encryption algorithms or mixing the results of the encryption algorithms with data which has not been encrypted. Lets assume a data object or 2000 bytes; five different encryption algorithms are applied to five different subsets of the original data. Each subset can be 400 bytes long so that five different encryption algorithms encrypt different subsets of the 2000 bytes. Assume for purpose of discussion that the encryption of the 2000 bytes of the original data result in 2000 bytes of encrypted or hidden data. We now “mix” the hidden data by taking a group of 50 bytes (for example bytes 51-101 of each 400 byte subset) and shift each group to the next higher subset, so that 50 bytes from the first subset are re-located in the second subset, the 50 bytes in the second subset displaced by the 50 bytes from the first subset are re-located to the third subset and so on; 50 bytes from the third subset are re-located to the fourth subset, 50 bytes from the fourth subset are re-located in the fifth subset and 50 bytes from the fifth subset are re-located in the first subset.

In order to decrypt this hidden data one needs to know the identity of the different encryption algorithms, the key used with each of the encryption algorithms, the subset of the data to which each algorithm was applied and the pattern for “mixing” which was employed.

### Embodiments of the “InvisiData™” Scrambling Process

This section outlines some of the embodiments of “InvisiData™” obfuscation as related to the “InvisiData™” technology. This does not limit the use of the “InvisiData™” technology, but more clearly identifies some of the ways in which the “InvisiData™” obfuscation technology can and/or will be utilized. In some instances below, additional steps are outlined that could be omitted, but provide an example of possible additional important functionality. It is understood that these examples are in no way an exhaustive list of embodiments and interactions possible for the “InvisiData™” obfuscation technology which includes definition of a method by which a combination of one or more compression, encryption, and/or bit manipulation schemes are pooled for use with one or more defining and/or modifying pre-shared and/or runtime-shared secrets. This technology allows for various combinations of use for the SO in order to enhance randomization whether using a single key/encryption or multiple encryptions and/or scramblers (SK/SP/SO variations) in combination.

In the embodiments below it is understood that specification of an SK, SP, and/or SO refers to any manner in which these values are negotiated and/or exchanged and/or pre-agreed by the party or parties storing and/or sharing the secrets, such as, but not limited to, pre-shared secrets, key exchange protocol negotiation, biometric derivation, user specification, random number generation, etc.

### Embodiment #1

### Compressed Data Archive Containing a Document File

The SD would be a compressed data archive containing a document file. The SP would specify that the SK and SP will both be used with linear wrapping. The SP would specify that zero valued counts from the SK should be ignored (as opposed to implementing a plus-one offset to SK values or assigning an arbitrary value to replace zero values). The SP would further specify that all data from the SD would be interpreted by using two bits, then three bits, then two bits from the SK as a set of counters for pattern scrambling, and that SD results would be arrayed in sets of three groupings of six SK offsets. The following sequence illustrates this example:

```
Original data:
00101001010100101010010000101010010
SK:
01100101101001010010
SK with SP applied: (raw)
01 100 10 11 010 01 01 001 00 11 001 01 10 100 10 10 010 01 10 010 11 01 001 01 . . .
SK with SP applied: (zero-filtered)
01 100 10 11 010 01 01 001 11 001 01 10 100 10 10 010 01 10 010 11 01 001 01 . . .
  1 4 2 3 2 1 1 1 3 1 1 2 4 2 2 2 1 2 2 3 1 1 1
Original data: (split)
0 0101 00 101 01 0 0 1 010 1 0 01 0000 10 10 1 00 10
Original data: (grouped every six offsets)
0 0101 00 101 01 0
                                    0 1 010 1 0 01
                                                                      0000 10 10 1 00 10
Original data: (re-grouped)
0 0 000
    0101 1 10
              00 010 10
                    101 1 1
                            01 0 00
                                  0 01 10
----or----
0 0 0000
0101 1 10
00 010 10
101 1 1
01 0 00
0 0110
Obfuscated data: (resulting scramble of original data)
00000001011100001010101110100000110
```

### Embodiment #2

### Digital Video File Containing a Medical Image

The SD would be a digital-video file containing a five-second segment from an endoscopy. The SP would specify that any occurrence of three or more consecutive zero bits in the SD should be converted to as many repetitions as necessary of three zeros followed by a sixteen bit floating point counter to represent the sequence correctly. The SP would also specify that the SK and SP will both be used with linear wrapping.

### Embodiment #3

### Compressed Data Archive Applying Multiple Combined Protections

The SD would be a compressed data archive containing a document file. The SP would specify that the SK and SP will both be used with rebounding wrapping. The SP would specify that zero valued counts from the SK should be interpreted as a two-count (as opposed to being ignored or another value substitution). The SP would further specify that all data from the SD would be interpreted by using three bits, then three bits, then two bits, then two bits from the SK as a set of counters for pattern scrambling, and that SD results would be arrayed in sets of four groupings of nine offset into the SK by the SO. The resulting obfuscated data would then be stored using 3DES encryption. The SP would further specify that after applying the 3DES a second scramble would be performed starting at the offset into the data specified by the SO and using the same method first applied but now interpreting zero counts as a three-count.

### Embodiment #4

### Complex Key Scrambling Definition

The SK used during obfuscation would be specified as alternately rebounding and wrapping while skipping, such that the procedure would use the key rebounding first then wrapping, then rebounding again, etc. and process the bit sequence by skip ahead in the key sequence by a set number of key bits specified in an SO after processing of another set number of key bits. The two skipping numbers (SOs) might be identical or different.

### Embodiment #4

### Simple Key Scrambling Definition

The SD would be a simple ASCII text file. The SK used during obfuscation would be specified as wrapping, such that the procedure would use the key in a wrap-around manner without any other variations. The SK would define a series of simple bit-swaps determined using the SO.

### Embodiment #5

### Complex Compound Runtime Definitions and Shared Secrets

The SD would be a computer file. The SK used during obfuscation would be specified as 532 bits long and containing a primary embedded 3 bit SO starting at bit 17, a secondary 2 bit SO starting at bit 192, a third SO 4 bits long starting at bit 500, a primary looping SP spanning bits 0 through 129, a secondary wrapping SP spanning bits 87 through 412, a third loop-bounce-loop-wrap-repeat SP spanning bits 390 through 532, an embedded 128 bit AES key starting at bit 49, and a 64 bit DES key starting at bit 291. The specified process would be to first scramble the SD using the primary SP starting at the position specified by the secondary SO, next performing an encryption using the DES key, next using the primary SO to indicate a starting point in the secondary SP to begin a two-pass scrambling at the position specified by the third SO, next running an AES encryption on the SD starting at the bit specified by the secondary SO and ending at the position specified in the third SO, and finally using the third SP with a pre-shared SO indicating the number of times to scramble the entire SD a final time.

1. Apparatus for transferring data from a source to a receptacle without exposing the data to unauthorized recipients or receptacles in the course of the transfer comprising:
a. At least one component for input and/or output of cleartext and/or protected data;
b. At least one storage component for storing data including, some or all of cleartext data, firmware, software, keys, shared secrets, and/or protected data;
c. At least one CPU component for instruction execution for performing at least one of:
i. Data management;
ii. Encryption;
iii. Decryption;
iv. Device control;
v. Communication;
vi. Calculation;
vii. Hashing;
viii. Zeroization;
ix. Redundancy;
d. At least one component for supplying power comprising at least one of battery, RF converter, power regulator, external power interface;
e. At least one component for biometric authentication; and
At least one tamper-evident, tamper-resistant, and/or tamper-proof component protecting at least a different of said components.

2. Apparatus for transferring data as recited in claim 1 including at least one component performing bit-level data manipulation, said bit-level data manipulation comprising at least one of,
a. bit-slice deconstruction, wherein a pattern is used for separating a single data stream and/or data element into many segments, regardless of machine dependant limitations by groups of one or more bits into groups of two or more distinct bit-streams, each bit-stream comprising a single bit-slice.
b. bit-slice reconstruction, wherein a pattern is used for recombining two or more bit-slices into their original bit sequence.
c. selective bounded bit rotation(s) and/or shift(s), wherein the domain for the bits to be shifted is unconstrained and may comprise any number of individual bits, where unconstrained refers to selecting any point of origin for a domain, a count of bits in the domain, and a number of bits applied as a rotation and/or shift, where domain refers to a set of bits against which the rotation and/or shift is applied and may be comprised of any number of bits available to either internally and/or externally,
d. selective bounded and/or unbounded bit swap(s), wherein a domain for bits to be swapped is unconstrained and may comprise any number of individual source bits and any number of individual destination bits, where unconstrained refers selecting any point of origin for a domain, a count of bits in the domain, and a number of bits applied as source and/or destination for the swap(s), domain refers to a set of bits against which a swap(s) is applied and may be comprised of any number of bits available internally and/or externally,
e. selective bounded and/or unbounded logical bit modification(s), wherein a domain for bits to be modified is unconstrained and may comprise any number of individual bits, unconstrained refers to selecting any point of origin for a domain, domain refers to a set of bits against which the logical operation is applied and may be comprised of any number of bits available internally and/or externally, where logical bit modification and logical operation refers to any computational logical operation, where
all of said bit-slice deconstruction, bit slice reconstruction, bit rotation, bit swaps and logical bit modifications may be constrained or influenced by one or more of raw randomly generated data, heuristically assembled data, fixed length sequences, dynamically created sequences, dynamically sized sequences, randomly sized sequences, pre-shared data, indexes, authentication tokens, biometric authenticators, authentication tokens, counters, chronological stamps, date and/or time stamps, offsets, size indicators, minimum limits, maximum limits, indexes, hashes, and tokens.

3. A method of transferring data from a source to a receptacle without exposing the data to unauthorized recipients or receptacles in the course of the transfer comprising:
providing a source including
a. At least one interface component for selective input and output of cleartext and protected data;
b. At least one storage component storing various data including identification data, partner data, cleartext data, software, secrets and protected data;
c. At least one CPU component for data processing effecting
a. Data management;
b. Encryption;
c. Device control;
d. Communication; and
d. At least one component facilitating biometric authentication; and
e. At least one control component allowing control to be exercised by a user subject to testing by said biometric authentication component
providing a receptacle including:
f. at least one interface component for selective input and output of cleartext and protected data;
g. at least one storage component storing various data including identification data, cleartext data, software, secrets and protected data;
h. at least one CPU component for data processing effecting
i. Data management;
ii. Decryption;
iii. Device control;
iv. Communication; and
i. At least one component facilitating biometric authentication;
said method further comprising
communicating protected data from said source to said receptacle in response to a request for said communication by a user authenticated by said biometric authentication component.

4. A method for transferring data as recited in claim 3 which includes executing at least two different encryption algorithms in a source prior to implementing a single transfer from source.

5. The method of claim 4, wherein each encryption algorithm is selectable from a set of encryption.

6. The method of claim 5 further including bit-slicing data at designated boundaries, plural bit-slices fed independently as the input data for multiple encryption processes.

7. Method for transferring data as recited in claim 3 which further includes data obfuscation, said obfuscation comprising at least one of bit deconstruction, bit reconstruction, bit swapping, bit rotation and logical bit modification.

8. The method of claim 7, wherein said data obfuscation is selectable from a set of multiple potential obfuscations.

9. The apparatus as recited in claim 1 including a secure personal information device (SPID) configured to store and retrieve protected data.

10. The apparatus as recited in claim 1 including a secure data storage manager (SDSM), configured to manage the protected data on the SPID.

11. The apparatus as recited in claim 10 wherein said SPID is configured to store data representing images, documents, databases, or audio or video content.

12. The apparatus as recited in claim 11 wherein said SPID is configured to release data when authenticated by a biometric parameter.

13. The apparatus as recited in claim 12 wherein said SPID is configured so the data to be released is defaulted to specific information.

14. The apparatus as recited in claim 13 wherein said SPID is configured to provide an automated, pre-specified set of choices.

15. The apparatus as recited in claim 14, incorporates authentication, key generation, key management, encryption, scrambling, and secure storage.

16. The apparatus as recited in claim 15 wherein said storage component stores separate access and protection rules for each piece of data subject to protection.

17. The apparatus as recited in claim 14 wherein said SPID is configured to never release as clear text data, data subject to protection.

18. The apparatus as recited in claim 14 wherein said SPID is configured to permanently erase specific data based on the alert/distress activation(s).

19. A method of hiding original data so that the original data is not available without information describing the manner in which the original data was hidden, said method comprising
applying a first data hiding process to a first portion of the original data to produce a first hidden portion of the original data so that the first portion of the original data cannot be deduced from the first hidden portion without information on the first data hiding process,
applying a second data hiding process to a second portion of the original data to produce a second hidden portion of the original data so that the second portion of the original data cannot be deduced from the second hidden portion without information on the second data hiding process,
selecting a first subset of the first hidden portion and a second subset of the second hidden portion and modifying the first hidden portion by placing the second subset into the location previously occupied by the first subset and modifying second hidden portion by placing the first subset into the location previously occupied by the second subset,
creating a final data set by replacing the first portion in the original data with the modified first hidden portion and replacing the second portion of the original data with the modified second hidden portion, and
using the final data set and information concerning the first and second data hiding processes and selections of the first and second subset to represent the original data.

20. The method of claim 19 wherein
a. said first data hiding process comprises encryption employing a first encryption process with a first encryption key,
b. said second data hiding process comprises a second encryption process, different from said first encryption process with a second encryption key,
c. said first and second portions of the original data comprising distinct portions of said original data.

21. The method of claim 19 wherein said first and second portions of the original data comprise all of the original data.

22. The method of claim 19 wherein further data hiding processes are applied to all said original data beyond said first and second portions of said original data.
